(19) United States
(12) Patent Application Publication
(10) Pub. No.: US 2025/0088879 A1
(43) Pub. Date: Mar. 13, 2025

(54) METRICS AND REPORT QUANTITIES FOR CROSS FREQUENCY RANGE PREDICTIVE BEAM MANAGEMENT

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Yan ZHOU, San Diego, CA (US); Tao LUO, San Diego, CA (US)

(21) Appl. No.: 18/728,189

(22) PCT Filed: Mar. 31, 2022
(86) PCT No.: PCT/CN2022/084423

§ 371 Date: Jul. 11, 2024

(51) Int. Cl. H04W 24/08; H04B 17/318; H04L 5/00; H04W 72/231

(52) U.S. Cl. CPC H04W 24/08; H04B 17/328; H04L 5/0051; H04W 72/231

(57) ABSTRACT

Wireless communications systems, apparatuses and methods related to communicating control information are provided. A user equipment (UE) may include a memory, a transceiver, and at least one processor coupled to the memory and the transceiver, wherein the UE is configured to receive a first reference signal associated with a first serving cell, measure at least one of a power delay profile (PDP) associated with the first reference signal or an angle of arrival (AOA) associated with the first reference signal, and determine a beam failure associated with a second reference signal associated with a second serving cell based on the at least one of the PDP or the AOA, wherein the second serving cell is different from the first serving cell.

### TECHNICAL FIELD

This application relates to wireless communication systems, and more particularly, to metrics and report quantities for cross frequency range predictive beam management.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed frequency bands and/or unlicensed frequency bands (e.g., shared frequency bands).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In an aspect of the disclosure, a method of wireless communication performed by a user equipment (UE), may include receiving a first reference signal associated with a first serving cell; measuring at least one of a power delay profile (PDP) associated with the first reference signal or an angle of arrival (AOA) associated with the first reference signal; and determining a beam failure associated with a second reference signal associated with a second serving cell based on the at least one of the PDP or the AOA, wherein the second serving cell is different from the first serving cell.

In an additional aspect of the disclosure, a method of wireless communication performed by a user equipment (UE) may include receiving a plurality of first reference signals associated with a first serving cell; measuring a reference signal received power (RSRP) associated with the plurality of first reference signals; receiving a plurality of second reference signals associated with the first serving cell; measuring an interference level associated with the plurality of second reference signals; determining a beam failure reason associated with a third reference signal configured in a second serving cell based on at least one of the RSRPs associated with the plurality of first reference signals satisfying a first threshold; or the interference levels associated with the plurality of second reference signals satisfying a second threshold; and transmitting, to a network unit of the first serving cell, an indication of the beam failure reason.

In an additional aspect of the disclosure, a method of wireless communication performed by a user equipment (UE) may include receiving, from a network unit, a configuration for a machine learning (ML) model, wherein the configuration comprises inputs to the ML model based on a reference signal received power (RSRP) associated with a first reference signal of a first serving cell and an interference level associated with a second reference signal of the first serving cell; training the ML model based on the input, wherein an output of the ML model includes at least one of an RSRP associated with a second reference signal of a second serving cell, an interference level associated with the second reference signal, or an expected beam failure determination reason associated with the second reference signal; receiving the second reference signal of the second serving cell; determining a ground truth beam failure determination reason associated with the second reference signal of the second serving cell based on at least one of the RSRP associated with the second reference signal of the second serving cell, an interference level associated with a third reference signal of the second serving cell, or the expected beam failure determination reason; and determining a loss function between the expected beam failure determination reason associated with the second reference signal of the second serving cell and the ground truth beam failure determination reason associated with the second reference signal of the second serving cell.

In an additional aspect of the disclosure, a method of wireless communication performed by a user equipment (UE) may include receiving a first reference signal associated with a first serving cell; measuring at least one of a power delay profile (PDP) associated with the first reference signal or an angle of arrival (AOA) associated with the first reference signal; receiving a second reference signal associated with a second serving cell; determining a block error rate (BLER) of a hypothetical physical downlink control channel (PDCCH) associated with the second reference signal; and transmitting, to a network unit of the first serving cell, at least one of an indicator indicating the PDP associated with the first reference signal; an indicator indicating the AOA associated with the first reference signal; or an indicator indicating the BLER of the hypothetical PDCCH associated with the second reference signal.

In an additional aspect of the disclosure, a user equipment (UE) may include a memory; a transceiver; and at least one processor coupled to the memory and the transceiver, wherein the UE is configured to receive a first reference signal associated with a first serving cell; measure at least one of a power delay profile (PDP) associated with the first reference signal or an angle of arrival (AOA) associated with the first reference signal; and determine a beam failure associated with a second reference signal associated with a second serving cell based on the at least one of the PDP or the AOA, wherein the second serving cell is different from the first serving cell.

In an additional aspect of the disclosure, a user equipment (UE) may include a memory; a transceiver; and at least one processor coupled to the memory and the transceiver, wherein the UE is configured to receive a plurality of first reference signals associated with a first serving cell; measure a reference signal received power (RSRP) associated with the plurality of first reference signals; receive a plurality of second reference signals associated with the first serving cell; measure an interference level associated with the plurality of second reference signals; determine a beam failure reason associated with a third reference signal configured in a second serving cell based on at least one of the RSRPs associated with the plurality of first reference signals satisfying a first threshold; or the interference levels associated with the plurality of second reference signals satisfying a second threshold; and transmit, to a network unit of the first serving cell, an indication of the beam failure reason.

In an additional aspect of the disclosure, a user equipment (UE) may include a memory; a transceiver; and at least one processor coupled to the memory and the transceiver, wherein the UE is configured to receive, from a network unit, a configuration for a machine learning (ML) model, wherein the configuration comprises an input to the ML model based on channel characteristics associated with a first reference signal of a first serving cell; train the ML model based on the input, wherein an output of the ML model includes an expected beam failure determination associated with a second reference signal of a second serving cell; receive the second reference signal of the second serving cell; determine a ground truth beam failure determination associated with the second reference signal of the second serving cell based on the received second reference signal of the second serving cell; and determine a loss function between the expected beam failure determination associated with the second reference signal of the second serving cell and the ground truth beam failure determination associated with the second reference signal of the second serving cell.

In an additional aspect of the disclosure, a user equipment (UE) may include a memory; a transceiver; and at least one processor coupled to the memory and the transceiver, wherein the UE is configured to receive, from a network unit, a configuration for a machine learning (ML) model, wherein the configuration comprises inputs to the ML model based on a reference signal received power (RSRP) associated with a first reference signal of a first serving cell and an interference level associated with a second reference signal of the first serving cell; train the ML model based on the input, wherein an output of the ML model includes at least one of an RSRP associated with a second reference signal of a second serving cell, an interference level associated with the second reference signal, or an expected beam failure determination reason associated with the second reference signal; receive the second reference signal of the second serving cell; determine a ground truth beam failure determination reason associated with the second reference signal of the second serving cell based on at least one of the RSRP associated with the second reference signal of the second serving cell, an interference level associated with a third reference signal of the second serving cell, or the expected beam failure determination reason; and determine a loss function between the expected beam failure determination reason associated with the second reference signal of the second serving cell and the ground truth beam failure determination reason associated with the second reference signal of the second serving cell.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure

FIG. 3 illustrates a dual connectivity wireless communication network according to some aspects of the present disclosure.

FIG. 4 is a signaling diagram of a wireless communication method according to some aspects of the present disclosure.

FIG. 5 is a signaling diagram of a wireless communication method according to some aspects of the present disclosure.

FIG. 6 is a block diagram of an exemplary user equipment (UE) according to some aspects of the present disclosure.

FIG. 7 is a block diagram of an exemplary network unit according to some aspects of the present disclosure.

FIG. 8 is a flow diagram of a communication method according to some aspects of the present disclosure.

FIG. 9 is a flow diagram of a communication method according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜ 1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mm Wave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The deployment of NR over an unlicensed spectrum is referred to as NR-unlicensed (NR-U). Federal Communications Commission (FCC) and European Telecommunications Standards Institute (ETSI) are working on regulating 6 GHz as a new unlicensed band for wireless communications. The addition of 6 GHz bands allows for hundreds of megahertz (MHz) of bandwidth (BW) available for unlicensed band communications. Additionally, NR-U can also be deployed over 2.4 GHz unlicensed bands, which are currently shared by various radio access technologies (RATs), such as IEEE 802.11 wireless local area network (WLAN) or WiFi and/or license assisted access (LAA). Sidelink communications may benefit from utilizing the additional bandwidth available in an unlicensed spectrum. However, channel access in a certain unlicensed spectrum may be regulated by authorities. For instance, some unlicensed bands may impose restrictions on the power spectral density (PSD) and/or minimum occupied channel bandwidth (OCB) for transmissions in the unlicensed bands. For example, the unlicensed national information infrastructure (UNII) radio band has a minimum OCB requirement of about 70 percent (%).

Some sidelink systems may operate over a 20 MHz bandwidth in an unlicensed band. A BS may configure a sidelink resource pool over the 20 MHz band for sidelink communications. A sidelink resource pool is typically partitioned into multiple frequency subchannels or frequency subbands (e.g., about 5 MHz each) and a sidelink UE may select a sidelink resource (e.g., a subchannel) from the sidelink resource pool for sidelink communication. To satisfy an OCB of about 70%, a sidelink resource pool may utilize a frequency-interlaced structure. For instance, a frequency-interlaced-based sidelink resource pools may include a plurality of frequency interlaces over the 20 MHz band, where each frequency interlace may include a plurality of resource blocks (RBs) distributed over the 20 MHz band. For example, the plurality of RBs of a frequency interlace may be spaced apart from each other by one or more other RBs in the 20 MHz unlicensed band. A sidelink UE may select a sidelink resource in the form of frequency interlaces from the sidelink resource pool for sidelink communication. In other words, sidelink transmissions may utilize a frequency-interlaced waveform to satisfy an OCB of the unlicensed band. However, S-SSBs may be transmitted in a set of contiguous RBs, for example, in about eleven contiguous RBs. As such, S-SSB transmissions alone may not meet the OCB requirement of the unlicensed band. Accordingly, it may be desirable for a sidelink sync UE to multiplex an S-SSB transmission with one or more channel state information reference signals (CSI-RSs) in a slot configured for S-SSB transmission so that the sidelink sync UE's transmission in the slot may comply with an OCB requirement.

The present application describes mechanisms for a sidelink UE to multiplex an S-SSB transmission with a CSI-RS transmission in a frequency band to satisfy an OCB of the frequency band. For instance, the sidelink UE may determine a multiplex configuration for multiplexing a CSI-RS transmission with an S-SSB transmission in a sidelink BWP. The sidelink UE may transmit the S-SSB transmission in the sidelink BWP during a sidelink slot. The sidelink UE may transmit one or more CSI-RSs in the sidelink BWP during the sidelink slot by multiplexing the CSI-RS and the S-SSB transmission based on the multiplex configuration.

In some aspects, the sidelink UE may transmit the S-SSB transmission at an offset from a lowest frequency of the sidelink BWP based on a synchronization raster (e.g., an NR-U sync raster). In some aspects, the sidelink UE may transmit the S-SSB transmission aligned to a lowest frequency of the sidelink BWP. For instance, a sync raster can be defined for sidelink such that the S-SSB transmission may be aligned to a lowest frequency of the sidelink BWP.

In some aspects, the multiplex configuration includes a configuration for multiplexing the S-SSB transmission with a frequency interlaced waveform sidelink transmission to meet the OCB requirement. For instance, the sidelink transmission may include a CSI-RS transmission multiplexed in frequency within a frequency interlace with RBs spaced apart in the sidelink BWP. In some instances, the sidelink UE may rate-match the CSI-RS transmission around RBs that are at least partially overlapping with the S-SSB transmission.

In some aspects, the multiplex configuration includes a configuration for multiplexing the S-SSB transmission with a subchannel-based sidelink transmission to meet the OCB requirement. For instance, the sidelink transmission may include a CSI-RS transmission multiplexed in time within a subchannel including contiguous RBs in the sidelink BWP. For instance, the S-SSB transmission may be transmitted at a low frequency portion of the sidelink BWP, and the CSI-RS may be transmitted in a subchannel located at a high frequency portion of the sidelink BWP to meet the OCB.

In some aspects, a BS may configure different sidelink resource pools for slots that are associated with S-SSB transmissions and for slots that are not associated with S-SSB transmissions. For instance, the BS may configure a first resource pool with a frequency-interlaced structure for slots that are not configured for S-SSB transmissions. The first resource pool may include a plurality of frequency interlaces (e.g., distributed RBs), where each frequency interlace may carry a PSCCH/PSSCH transmission. The BS may configure a second resource pool with a subchannel-based structure for slots that are configured for S-SSB transmission. The second resource pool may include a plurality of frequency subchannels (e.g., contiguous RBs), where each subchannel may carry a PSCCH/PSSCH transmission. To satisfy an OCB in a sidelink slot configured for an S-SSB transmission, the sidelink UE (e.g., a sidelink sync UE) may transmit an S-SSB transmission multiplexed with a CSI-RS transmission. For instance, the S-SSB transmission may be transmitted in frequency resources located at a lower frequency portion of a sidelink BWP and the CSI-RS transmission may be transmitted in frequency resources located at higher frequency portion of the sidelink BWP.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

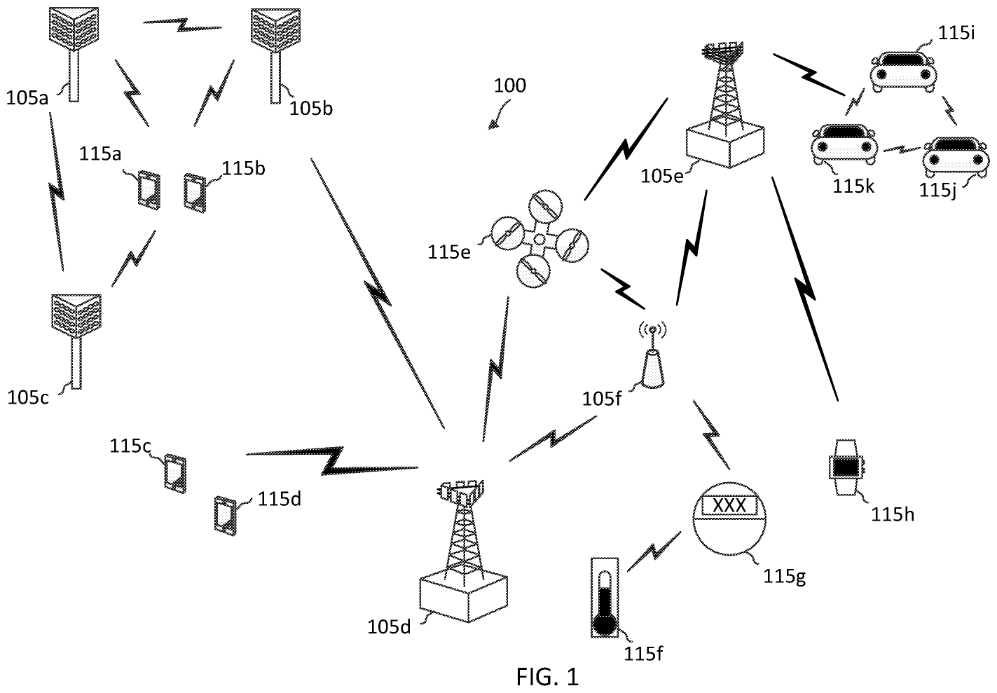

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. In some aspects, the UE 115h may harvest energy from an ambient environment associated with the UE 115h. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

The network 100 may be designed to enable a wide range of use cases. While in some examples a network 100 may utilize monolithic base stations, there are a number of other architectures which may be used to perform aspects of the present disclosure. For example, a BS 105 may be separated into a remote radio head (RRH) and baseband unit (BBU). BBUs may be centralized into a BBU pool and connected to RRHs through low-latency and high-bandwidth transport links, such as optical transport links. BBU pools may be cloud-based resources. In some aspects, baseband processing is performed on virtualized servers running in data centers rather than being co-located with a BS 105. In another example, based station functionality may be split between a remote unit (RU), distributed unit (DU), and a central unit (CU). An RU generally performs low physical layer functions while a DU performs higher layer functions, which may include higher physical layer functions. A CU performs the higher RAN functions, such as radio resource control (RRC).

For simplicity of discussion, the present disclosure refers to methods of the present disclosure being performed by base stations, or more generally network entities, while the functionality may be performed by a variety of architectures other than a monolithic base station. In addition to disaggregated base stations, aspects of the present disclosure may also be performed by a centralized unit (CU), a distributed unit (DU), a radio unit (RU), a Near-Real Time (Near-RT) RAN Intelligent Controller (RIC), a Non-Real Time (Non-RT) RIC, integrated access and backhaul (IAB) node, a relay node, a sidelink node, etc.

In some aspects, a method of wireless communication may be performed by the UE 115. The method may include receiving a first reference signal associated with the BS 105a, measuring at least one of a power delay profile (PDP) associated with the first reference signal or an angle of arrival (AOA) associated with the first reference signal, and determining a beam failure associated with a second reference signal associated with the BS 105b based on the at least one of the PDP or the AOA, wherein the BS 105a is different from the BS 105b.

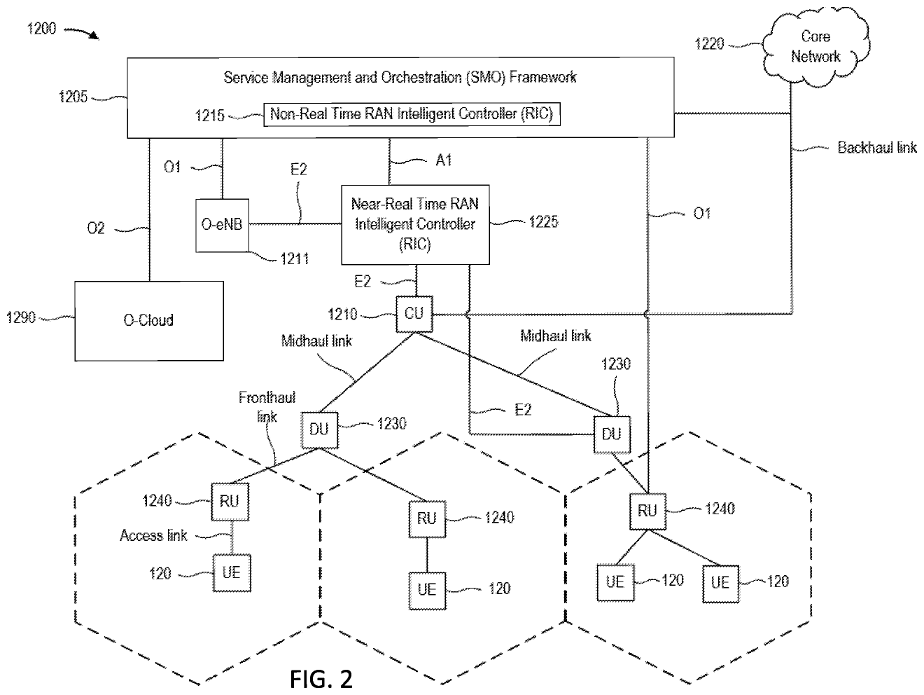

FIG. 2 shows a diagram illustrating an example disaggregated base station 1200 architecture. The disaggregated base station 1200 architecture may include one or more central units (CUs) 1210 that can communicate directly with a core network 1220 via a backhaul link, or indirectly with the core network 1220 through one or more disaggregated base station units (such as a Near-Real Time (Near-RT) RAN Intelligent Controller (RIC) 1225 via an E2 link, or a Non-Real Time (Non-RT) RIC 1215 associated with a Service Management and Orchestration (SMO) Framework 1205, or both). A CU 1210 may communicate with one or more distributed units (DUs) 1230 via respective midhaul links, such as an F1 interface. The DUs 1230 may communicate with one or more radio units (RUs) 1240 via respective fronthaul links. The RUs 1240 may communicate with respective UEs 120 via one or more radio frequency (RF) access links. In some implementations, the UE 120 may be simultaneously served by multiple RUs 1240.

Each of the units, i.e., the CUS 1210, the DUs 1230, the RUs 1240, as well as the Near-RT RICs 1225, the Non-RT RICs 1215 and the SMO Framework 1205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1210. The CU 1210 may be configured to handle user plane functionality (i.e., Central Unit-User Plane (CU-UP)), control plane functionality (i.e., Central Unit-Control Plane (CU-CP)), or a combination thereof. In some implementations, the CU 1210 can be logically split into one or more CU-UP units and one or more CU-CP units. The CU-UP unit can communicate bidirectionally with the CU-CP unit via an interface, such as the E1 interface when implemented in an O-RAN configuration. The CU 1210 can be implemented to communicate with the DU 1230, as necessary, for network control and signaling.

The DU 1230 may correspond to a logical unit that includes one or more base station functions to control the operation of one or more RUs 1240. In some aspects, the DU 1230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1230 may further host one or more low PHY layers. Each layer (or module) can be implemented with an interface configured to communicate signals with other layers (and modules) hosted by the DU 1230, or with the control functions hosted by the CU 1210.

Lower-layer functionality can be implemented by one or more RUs 1240. In some deployments, an RU 1240, controlled by a DU 1230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1240 can be implemented to handle over the air (OTA) communication with one or more UEs 120. In some implementations, real-time and non-real-time aspects of control and user plane communication with the RU(s) 1240 can be controlled by the corresponding DU 1230. In some scenarios, this configuration can enable the DU(s) 1230 and the CU 1210 to be implemented in a cloud-based RAN architecture, such as a vRAN architecture.

The SMO Framework 1205 may be configured to support RAN deployment and provisioning of non-virtualized and virtualized network elements. For non-virtualized network elements, the SMO Framework 1205 may be configured to support the deployment of dedicated physical resources for RAN coverage requirements which may be managed via an operations and maintenance interface (such as an O1 interface). For virtualized network elements, the SMO Framework 1205 may be configured to interact with a cloud computing platform (such as an open cloud (O-Cloud) 1290) to perform network element life cycle management (such as to instantiate virtualized network elements) via a cloud computing platform interface (such as an O2 interface). Such virtualized network elements can include, but are not limited to, CUs 1210, DUs 1230, RUs 1240 and Near-RT RICs 1225. In some implementations, the SMO Framework 1205 can communicate with a hardware aspect of a 4G RAN, such as an open eNB (O-eNB) 1211, via an O1 interface. Additionally, in some implementations, the SMO Framework 1205 can communicate directly with one or more RUs 1240 via an O1 interface. The SMO Framework 1205 also may include a Non-RT RIC 1215 configured to support functionality of the SMO Framework 1205.

The Non-RT RIC 1215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1225. The Non-RT RIC 1215 may be coupled to or communicate with (such as via an A1 interface) the Near-RT RIC 1225. The Near-RT RIC 1225 may be configured to include a logical function that enables near-real-time control and optimization of RAN elements and resources via data collection and actions over an interface (such as via an E2 interface) connecting one or more CUs 1210, one or more DUs 1230, or both, as well as an O-eNB, with the Near-RT RIC 1225.

In some implementations, to generate AI/ML models to be deployed in the Near-RT RIC 1225, the Non-RT RIC 1215 may receive parameters or external enrichment information from external servers. Such information may be utilized by the Near-RT RIC 1225 and may be received at the SMO Framework 1205 or the Non-RT RIC 1215 from non-network data sources or from network functions. In some examples, the Non-RT RIC 1215 or the Near-RT RIC 1225 may be configured to tune RAN behavior or performance. For example, the Non-RT RIC 1215 may monitor long-term trends and patterns for performance and employ AI/ML models to perform corrective actions through the SMO Framework 1205 (such as reconfiguration via 01) or via creation of RAN management policies (such as A1 policies).

In some aspects, a method of wireless communication may be performed by the UE 120. The method may include monitoring a first set of physical downlink control channel (PDCCH) candidate resources for a PDCCH communication from the RU 1240, receiving, from the RU 1240, a plurality of demodulation reference signals (DMRSs) and decoding, based on a metric associated with the plurality of demodulation reference signals (DMRSs) satisfying a threshold, the PDCCH communication.

In some aspects, a method of wireless communication may be performed by the UE 120. The method may include receiving a first reference signal associated with a first RU 1240, measuring at least one of a power delay profile (PDP) associated with the first reference signal or an angle of arrival (AOA) associated with the first reference signal, and determining a beam failure associated with a second reference signal associated with a second RU 1240 based on the at least one of the PDP or the AOA, wherein the first RU 1240 is different from the second RU 1240.

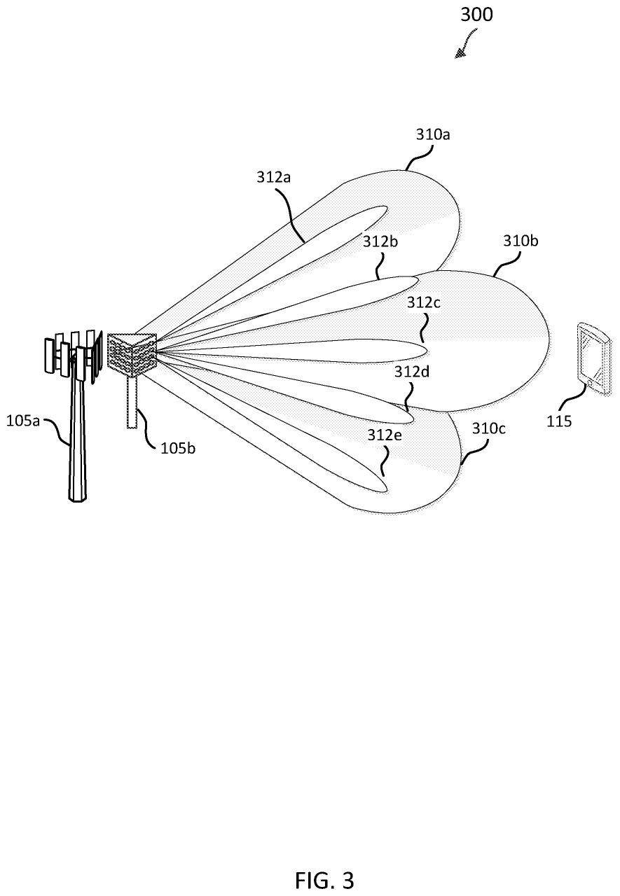

FIG. 3 illustrates an example of a wireless communications network 300 that supports dual connectivity according to some aspects of the present disclosure. The wireless communications network 300 may implement aspects of the wireless communications network 100, or 200 as described with reference to FIGS. 1 and 2. The wireless communications network 300 may include a UE 115 which may be an example of a UE 115, UE 120, or UE 600 as described herein. The wireless communications network 300 may also include a network unit (e.g., a BS 105a) operating as a first serving cell in an FR1 frequency range and a network unit (e.g., a BS 105b) operating as a second serving cell in an FR2 frequency range. In some aspects, the BS 105a may communicate with the UE 115 using directional communications techniques. For example, the BS 105a may communicate with the UE 115 via one or more beams 310. The BS 105a may communicate with the UE 115a via a communication link which may be an example of an NR or LTE link between the UE 115a and the BS 105a. The communication link may include a bi-directional link that enables both uplink and downlink communication. For example, the UE 115 may transmit uplink signals, such as uplink control signals or uplink data signals, to the BS 105a using the communication link and the base station 105a may transmit downlink signals, such as downlink control signals or downlink data signals, to the UE 115a using the communication link.

In some aspects, the UE 115 may receive a first reference signal associated with the BS 105a. The UE may receive the first reference signal over one or more of beams 310a, 310b, and/or 310c. The UE 115 may measure at least one of a power delay profile (PDP) associated with the first reference signal or an angle of arrival (AOA) associated with the first reference signal. The UE may determine a beam failure associated with a second reference signal associated with the BS 105b based on the at least one of the PDP or the AOA. For example, the UE 115 may determine a beam failure associated a reference signal in any one of beams 312a, 312b, 312c, 312d, or 312e based on the at least one of the PDP or the AOA associated with the first reference signal. The BS 105a and the BS 105b may be colocated or located at different locations.

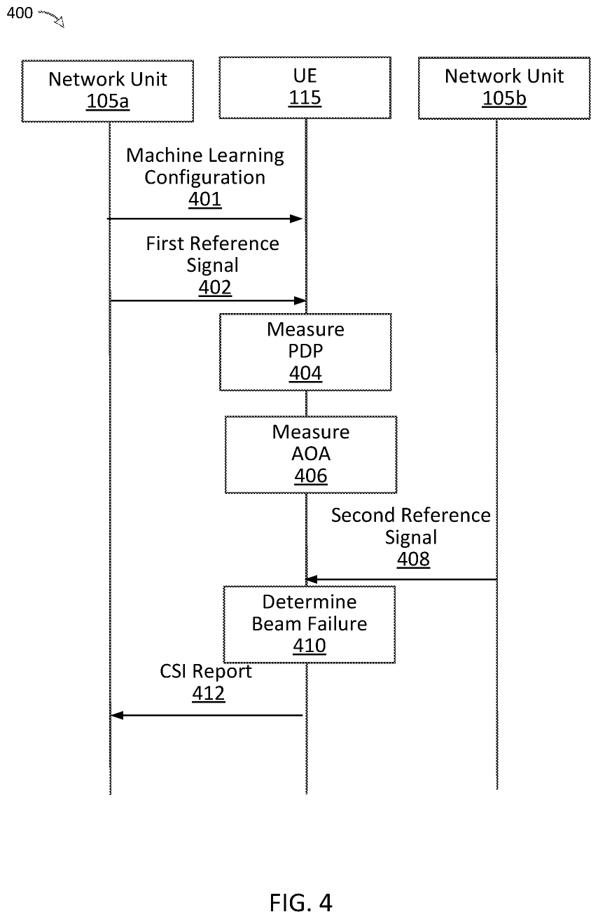

FIG. 4 is a flow diagram of a wireless communication method 400 according to some aspects of the present disclosure. Actions of the communication method 400 can be executed by a computing device (e.g., a processor, processing circuit, and/or other suitable component) of a communication device or other suitable means for performing the actions. For example, a wireless communication device, such as the UE 115, UE 120, or UE 600, may utilize one or more components, such as the processor 602, the memory 604, the beam failure detection module 608, the transceiver 610, the modem 612, and the one or more antennas 616, to execute aspects of method 400.

At action 401, the UE 115 may receive a machine learning configuration from the network unit 105a. In this regard, the UE 115 may receive the machine learning configuration from the network unit 105a via RRC signaling, a PDCCH communication, a PDSCH communication, or other suitable communication. A machine learning model used to determine beam failure in network unit 105b may be configured based on the machine learning configuration. The machine learning configuration may include, without limitation, identification of ML model inputs, weights, vectors, coefficients, equations, algorithms, type of ML model, etc.

At action 402, the UE 115 may receive a first reference signal from a network unit 105a (e.g., BS 105a). The BS 105a may be a first serving cell. The first reference signal may include a channel state information reference signal (CSI-RS), a synchronization signal block (SSB), and/or other reference signal. In some aspects, the first serving cell may be a serving cell operating in at least frequency range 1 (FR1). The FR1 may include frequencies in the range of about 4.1 GHz to about 7.125 GHz. In addition to or in lieu of FR1, the first serving cell may operate in one or more other frequency ranges.

At action 404, the method 400 includes the UE 115 measuring a power delay profile (PDP) associated with the first reference signal. The PDP may characterize a multipath channel between the UE 115 and the first serving cell. The UE 115 may measure the PDP associated with the first reference signal using any suitable method. For example, the reference signal received power (RSRP) of a plurality of delay paths associated with the first reference signal may be measured and the respective propagation delay of each delay path may be determined and/or recorded.

At action 406, the method 400 includes the UE 115 measuring an angle of arrival (AOA) associated with the first reference signal. The AOA may represent the direction of propagation of the first reference signal with respect to the UE 115. The UE 115 may measure the AOA associated with the first reference signal using any suitable method. For example, the UE 115 may measure the AOA associated with a plurality of delay paths based on a time difference of arrival and/or a received phase associated with the first reference signal. The AOA may be represented as an azimuth angle and/or an elevation angle relative to the first serving cell.

At action 408, the UE 115 may receive a second reference signal from a network unit 105b (e.g., BS 105b). The BS 105b may be a second serving cell operating in an FR2 frequency band.

At action 410, the method 400 includes the UE 115 determining a beam failure associated with the second reference signal associated with the second serving cell based on the first reference signal. In some instances, the UE 115 may determine the beam failure associated with the second reference signal based on at least one of the PDP measure at action 404 and/or the AOA measured at action 406. In some instances, the UE 115 may determine the beam failure associated with the second reference signal based on the PDP using one or more of a received signal strength indicator (RSSI) associated with the first reference signal, a reference signal received power (RSRP) associated with the first reference signal, a number of delay paths associated with the first reference signal, a reference signal received quality (RSRQ) associated with the first reference signal, and/or a signal-to-noise and interference ratio (SINR) associated with the first reference signal. In some instances, the UE may determine the beam failure associated with the second reference signal based on the AOA using one or more of a time difference of arrival and/or a received phase associated with the first reference signal.

In some aspects, the second serving cell (e.g., network unit 105b) is different from the first serving cell (e.g., network unit 105a). In this regard, the first serving cell may be a serving cell operating in at least FR1 while the second serving cell may be a serving cell operating in at least frequency range 2 (FR2). The FR2 frequency range may include frequencies in the range of about 24.25 GHz to about 52.6 GHz. In addition to or in lieu of FR1, the second serving cell may operate in one or more other frequency ranges. For example, the second serving cell may operate in frequency ranges above 52.6 GHz. In some aspects, the first serving cell may be in a master cell group (MCG) and the second serving cell may be in a secondary cell group (SCG). The wireless network (e.g., wireless network 100, 200, or 300) may operate in a dual connectivity mode in which the UE is connected to the first serving cell in a master cell group (MCG) and the second serving cell in a secondary cell group (SCG). The MCG may be a group of serving cells associated with a master eNB (MeNB) operating at FR1 frequencies and/or one or more other frequency ranges. The SCG may be a group of serving cells associated with a secondary eNB (SeNB) operating at FR2 frequencies and/or one or more other frequency ranges.

In some aspects, the UE 115 may determine the beam failure associated with the second reference signal based on a reference signal received power (RSRP), a RSSI, a RSRQ, and/or a SINR associated with a line of sight path of the first reference signal satisfying a first threshold. The line of sight path of the first reference signal may be a direct path from the network unit 105a to the UE 115 (e.g., a path without multipath reflections). The RSRP of the line of sight path of the first reference signal may be included in the PDP determined at action 404. The RSRP of the line of sight path of the first reference signal may have the highest RSRP of all paths included in the PDP. The line of sight path may have the shortest delay path associated with the first reference signal. The UE 115 may measure the RSRP associated with the line of sight path of the first reference signal as the linear average over the power contributions of the resource elements that carry the first reference signal. In some instances, the UE 115 may determine the beam failure based on the RSRP being less than or equal to the first threshold. The first threshold may be preconfigured in the UE 115. Additionally or alternatively, the UE 115 may receive an indicator indicating the first threshold from the network unit via RRC signaling or other communication.

In some aspects, the UE 115 may determine the beam failure associated with the second reference signal based on determining a RSRP, a RSSI, a RSRQ, and/or a SINR associated with a non-line of sight (NLOS) path of the first reference signal satisfies a second threshold. The NLOS path of the first reference signal may be an indirect path from the network unit to the UE 115 resulting from multipath reflections of the first reference signal. The UE 115 may measure the RSRP associated with a NLOS path of the first reference signal as the linear average over the power contributions of the resource elements that carry the first reference signal over the NLOS path. In some instances, the UE 115 may determine the beam failure based on the RSRP of the NLOS path being less than or equal to the second threshold. The second threshold may be preconfigured in the UE 115. Additionally or alternatively, the UE 115 may receive an indicator indicating the second threshold from the network unit 105a via RRC signaling or other communication.

In some aspects, the UE 115 may determine the beam failure associated with the second reference signal based on determining a number of delay paths associated with the first reference signal that satisfy a third threshold. In this regard, the UE 115 may identify the number of delay paths associated with the first reference signal. The number of delay paths may be identified based on the PDP at action 404. In some instances, the UE 115 may determine the beam failure based on the number of delay paths associated with the first reference signal being greater than or equal to the third threshold. The third threshold may be preconfigured in the UE 115. Additionally or alternatively, the UE 115 may receive an indicator indicating the third threshold from the network unit 105a via RRC signaling or other communication.

In some aspects, the UE 115 may determine the beam failure associated with the second reference signal based on the AOA associated with the first reference signal satisfying an AOA range. In this regard, the UE 115 may determine the AOAs associated with a number of delay paths of the first reference signal within a delay window (e.g., a time duration). In some instances, the UE 115 may determine the beam failure based on the AOAs associated with the number of delay paths of the first reference signal within the delay window being within the AOA range. In some instances, the UE 115 may determine the beam failure associated with the second reference signal based on the AOA using one or more of a time difference of arrival and/or a received phase associated with the first reference signal. Additionally or alternatively, the UE 115 may determine the beam failure based on the AOAs associated with the number of delay paths of the first reference signal within the delay window being outside the AOA range. In some aspects, the AOA range may be an azimuth angle range relative to the line of site path, an elevation angle range relative to the line of site path, and/or other suitable AOA range. The AOA range may be preconfigured in the UE 115. Additionally or alternatively, the UE 115 may receive an indicator indicating the AOA range from the network unit 105a via RRC signaling or other communication.

In some aspects, the UE 115 may determine the beam failure associated with the second reference signal based on determining a block error rate (BLER) of a hypothetical physical downlink control channel (PDCCH) associated with the first reference signal satisfies a fourth threshold. The hypothetical PDCCH for BLER determination may utilize aspects of the 3GPP specification TS 36.133 in terms of downlink control information (DCI) format, aggregation level, and/or resource element (RE) energy ratio. The UE 115 may determine the BLER based on an estimation and/or prediction of the BLER. The BLER may be a ratio of the number of blocks incorrectly received to the number of blocks correctly received by the UE 115. In some instances, the UE 115 may determine the beam failure based on the BLER of the hypothetical PDCCH being greater than the fourth threshold. The fourth threshold may be preconfigured in the UE 115. Additionally or alternatively, the UE 115 may receive an indicator indicating the fourth threshold from the network unit 105a via RRC signaling or other communication.

In some aspects, the UE 115 may determine the beam failure associated with the second reference signal based on determining a probability of the beam failure satisfies a threshold (e.g., a probability threshold). The UE 115 may determine the probability of beam failure based on a machine learning model. The machine learning model may include an artificial neural network (e.g., a convolutional neural network, a recurrent neural network, or other suitable neural network). The machine learning model may be used with parameters associated with the first reference signal as inputs. For example, the inputs to the machine learning model may include, without limitation, the delay spread associated with the multiple paths of the first reference signal, the RSRP associated with the multiple paths of the first reference signal, the PDP associated with the first reference signal as determined at action 404, the AOA associated with the multiple paths of the first reference signal as determined at action 406, and/or the BLER of a hypothetical PDCCH associated with the first reference signal. The output of the machine learning model may be a probability of beam failure associated with the second reference signal. The probability of beam failure associated with the second reference signal may have a value between 0 and 1. The probability threshold may also have a value between 0 and 1. The UE 115 may compare the probability value to the probability threshold. If the probability value is higher than the probability threshold, the UE 115 determines a beam failure associated with the second reference signal. The UE 115 may report the beam failure to the network unit 105a as a binary indicator (e.g., beam failure or no beam failure). Additionally or alternatively, the UE 115 may report the probability value to the network unit 105a. The probability threshold may be preconfigured in the UE 115. Additionally or alternatively, the UE 115 may receive an indicator indicating the probability threshold from the network unit 105a via RRC signaling or other communication.

In some aspects, the UE 115 may determine the beam failure associated with the second reference signal based on a block error rate (BLER) of a hypothetical physical downlink control channel (PDCCH) associated with the second reference signal satisfying a BLER threshold. The UE 115 may determine the BLER of the hypothetical PDCCH based on a machine learning model. The machine learning model may include an artificial neural network (e.g., a convolutional neural network, a recurrent neural network, or other suitable neural network). The machine learning model may be the same or different from the machine learning model used to determine a probability of the beam failure. The machine learning model may be used with parameters associated with the first reference signal as inputs. For example, the inputs to the machine learning model may include, without limitation, the PDP associated with the first reference signal, the AOA associated with the first reference signal, and/or the BLER of a hypothetical PDCCH associated with the first reference signal. The output of the machine learning model may be a BLER of a hypothetical PDCCH associated with the second reference signal. The UE 115 may determine a beam failure associated with the second reference signal based on the BLER being higher than a BLER threshold. The BLER threshold may be preconfigured in the UE 115. Additionally or alternatively, the UE 115 may receive an indicator indicating the BLER threshold from the network unit 105a via RRC signaling or other communication.

In some aspects, the UE 115 may determine features of a plurality of first reference signals associated with the first serving cell based on a plurality of first machine learning models. The UE 115 may determine a probability of the beam failure associated with the second reference signal based on using the features associated with the plurality of first reference signals as inputs to a second machine learning model. In other words, a plurality of first machine learning models may use a plurality of first reference signals as inputs. The outputs of the plurality of first machine learning models may be the features (e.g., PDP, AOA, RSRP, interference level, etc.) of the first reference signals. The features of the first reference signals may be inputs to a second machine learning model. The output of the second machine learning model may be a probability of beam failure associated with the second reference signal. The UE 115 may determine a beam failure associated with the second reference signal based on the probability being higher than a probability threshold. The probability threshold may be preconfigured in the UE 115. Additionally or alternatively, the UE 115 may receive an indicator indicating the probability threshold from the network unit 105a via RRC signaling or other communication. The first machine learning model may be the same or different from the second machine learning model.

In some aspects, the UE 115 may determine features of a plurality of first reference signals associated with the first serving cell based on a plurality of first machine learning models. The features associated with the plurality of first reference signals may be inputs to a third machine learning model. In other words, a plurality of first machine learning models may use a plurality of first reference signals as inputs. The outputs of the plurality of first machine learning models may be features (e.g., PDP, AOA, RSRP, interference level, etc.) of the first reference signals. The features of the first reference signals may be inputs to a third machine learning model. The output of the third machine learning model may be a BLER of a hypothetical PDCCH associated with the second reference signal. The UE 115 may determine a beam failure associated with the second reference signal based on the BLER being higher than a BLER threshold. The BLER threshold may be preconfigured in the UE 115. Additionally or alternatively, the UE 115 may receive an indicator indicating the BLER threshold from the network unit 105a via RRC signaling or other communication. The first machine learning model may be the same or different from the third machine learning model.

At action 412, the UE 115 may transmit an indicator via at least one CSI report to the network unit 105a. In this regard, the UE may transmit an indicator to the network unit 105a via at least one CSI report or other suitable communication. The UE 115 may transmit the indicator to the network unit 105a via at least one CSI report periodically or aperiodically. For example, the UE 115 may transmit the at least one CSI report periodically via a PUCCH and/or aperiodically via a PUSCH or other suitable communication. In some aspects, the indicator transmitted to the network unit 105a may indicate the PDP associated with the first reference signal. The PDP indicator may include the RSRP, RSSI, RSRQ, and/or SINR of a plurality of delay paths associated with the first reference signal and the respective propagation delay of each delay path. In some aspects, the indicator may indicate the AOA associated with the first reference signal. The AOA indicator may include the AOA (e.g., azimuth angle and/or an elevation angle relative to the first serving cell) associated with a plurality of delay paths associated with the first reference signal. In some aspects, the indicator may indicate the BLER of the hypothetical PDCCH associated with the second reference signal. The BLER indicator may be reported as a ratio (e.g., a percentage), an indicator relative to a beam out of sync threshold (e.g., Qout), and/or an indicator relative to a beam in sync threshold (e.g., Qin). In some aspects, the indicator may indicate the probability of the beam failure associated with the second reference signal. The UE 115 may report the beam failure to the network unit 105a as a binary indicator (e.g., beam failure or no beam failure). Additionally or alternatively, the UE 115 may report the probability value to the network unit 105a. In this regard, the UE 115 may transmit the indicator to the network unit 105a via at least one CSI report, a medium access control control element (MAC-CE), uplink control information (UCI), a PUCCH communication, a PUSCH communication, or other suitable communication.

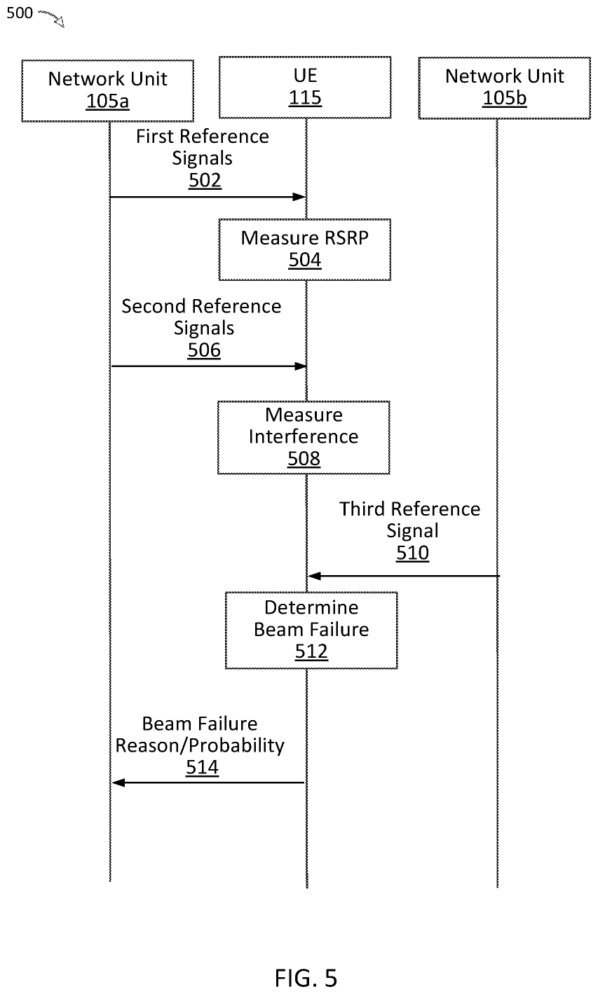

FIG. 5 is a flow diagram of a wireless communication method 500 according to some aspects of the present disclosure. Actions of the communication method 500 can be executed by a computing device (e.g., a processor, processing circuit, and/or other suitable component) of a communication device or other suitable means for performing the actions. For example, a wireless communication device, such as the UE 115, UE 120, or UE 600, may utilize one or more components, such as the processor 602, the memory 604, the beam failure detection module 608, the transceiver 610, the modem 612, and the one or more antennas 616, to execute aspects of method 500.

At action 502, the method 500 includes the UE 115 receiving a plurality of first reference signals from the network unit 105a associated with a first serving cell. The plurality of first reference signals may include channel state information reference signals (CSI-RSs), a synchronization signal blocks (SSBs), and/or other reference signals. In some aspects, the network unit 105a may be a first serving cell operating in at least frequency range 1 (FR1). The FR1 may include frequencies in the range of about 4.1 GHz to about 7.125 GHz. In addition to or in lieu of FR1, the first serving cell may operate in one or more other frequency ranges.

At action 504, the method 500 includes the UE 115 measuring a reference signal received power (RSRP) associated with the plurality of first reference signals, a received signal strength indicator (RSSI) associated with the plurality of first reference signals, a number of delay paths associated with the plurality of first reference signals, a reference signal received quality (RSRQ) associated with the plurality of first reference signals, and/or a signal-to-noise and interference ratio (SINR) associated with the plurality of first reference signals. In this regard, the UE 115 may measure the RSRP associated with the plurality of first reference signals as the linear average over the power contributions of the resource elements that carry the plurality of first reference signals.

At action 506, the method 500 includes the UE 115 receiving a plurality of second reference signals associated with the first serving cell from the network unit 105a. The plurality of second reference signals may include channel state information reference signals (CSI-RSs), a synchronization signal blocks (SSBs), and/or other reference signals. The plurality of second reference signals may include zero power (ZP-CSI-RSs).

At action 508, the method 500 includes the UE 115 measuring an interference level associated with the plurality of second reference signals. The interference measurement may be indicated as a power level (e.g., in units of dBm) and/or as a relative measurement in units of decibels (e.g., relative to the RSRP of the first reference signal and/or the second reference signal). The plurality of second reference signals may be configured as zero power (ZP-CSI-RS). The plurality of ZP-CSI-RSs may enable the UE 115 to measure interference levels from interference sources. The zero power CSI-RSs may contribute no interference to the interference measurement allowing the interference measurements to determine the level of interference from other sources include interference from transmissions by other UEs, transmissions by other serving cells, and interference from other radio frequency producing devices.

At action 510, the method 500 includes the UE 115 receiving a third reference signal from the network unit 105b associated with a second serving cell.

At action 512, the method 500 includes the UE 115 determining a beam failure reason associated with the third reference signal configured in the second serving cell. The beam failure reason may include a signal and/or interference measurement satisfying a threshold. The first serving cell may be a serving cell operating in at least FR1 while the second serving cell may be a serving cell operating in at least frequency range 2 (FR2). In some aspects, the UE 115 may determine the beam failure reason associated with the third reference signal based on the RSRPs associated with the plurality of first reference signals satisfying a first threshold. For example, the UE 115 may determine the beam failure reason associated with the third reference signal based on the RSRPs associated with the plurality of first reference signals being less than or equal to the first threshold.

In some aspects, the UE 115 may determine the beam failure reason associated with the third reference signal based on the interference levels associated with the plurality of second reference signals satisfying a second threshold. For example, the UE 115 may determine the beam failure reason associated with the third reference signal based on the interference level associated with the second reference signals being greater than the second threshold. The first threshold may be different from the second threshold. The beam failure reason associated with the third reference signal may be based on the RSRPs associated with the plurality of first reference signals satisfying a first threshold and/or the interference level associated with the second reference signals being greater than the second threshold.

At action 514, the method 500 includes the UE 115 transmitting an indication of the beam failure reason to the network unit 105a of the first serving cell. In this regard, the UE 115 may transmit the indication of the beam failure reason to the network unit 105a via a CSI report, a medium access control-control element (MAC-CE), a physical uplink control channel (PUCCH) scheduling request (SR), or other suitable communication. The UE 115 may indicate the beam failure reason using any suitable format, including without limitation a bitmap, a table, a numerical value, and/or other data structure.

In some aspects, the UE 115 may transmit the indication of the beam failure reason to the network unit 105a via a candidate reference signal identifier of a first list of candidate reference signal identifiers associated with RSRP measurements in the second serving cell. In this regard, the UE 115 may be configured with a list of candidate reference signal identifiers that correspond to an associated beam failure reason. Accordingly, in some instances the UE 115 may utilize the candidate reference signal identifier(s) associated with a particular beam failure reason to indicate the beam failure reason. The UE 115 may report the beam failure reason by transmitting the candidate reference signal identifier(s) in the MAC-CE that correspond to the determined beam failure reason. For example, a list of candidate reference signal identifiers associated with the first serving cell may be used to indicate a beam failure reason based on RSRPs associated with the plurality of first reference signals being less than or equal to the first threshold. For another example, a list of candidate reference signal identifiers associated with the second serving cell may be used to indicate a beam failure reason based on the interference level associated with the second reference signals being greater than the second threshold.

In some aspects, the UE 115 may transmit an indicator to the network unit 105a indicating the probability of the beam failure reason. The probability of the beam failure reason may be based on the RSRPs associated with the plurality of first reference signals being less than or equal to the first threshold and/or the interference levels associated with the second reference signals being greater than the second threshold. In this regard, the UE 115 may transmit the indicator indicating the probability of the beam failure reason via a CSI report, a MAC-CE, UCI, a PUCCH communication, or other suitable communication. The UE 115 may indicate the probability of the beam failure reason using any suitable format, including without limitation a bitmap, a table, a numerical value, and/or other data structure.

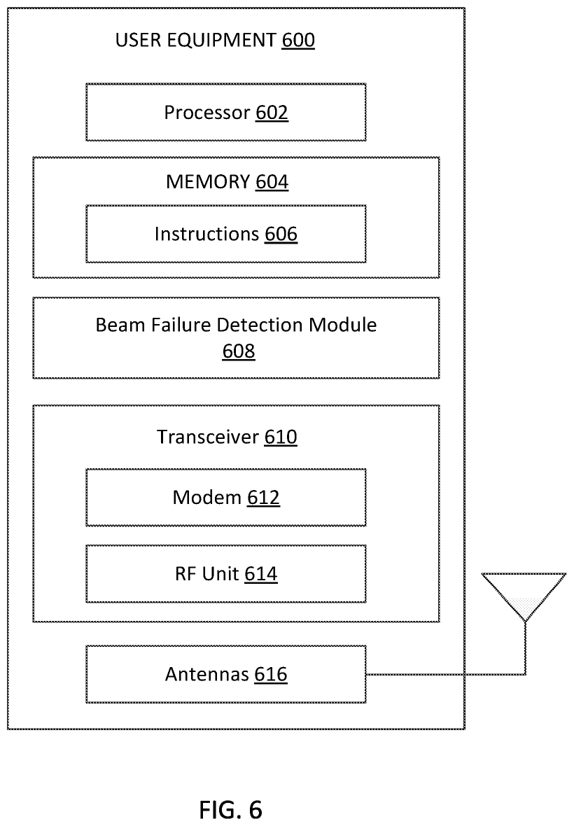

FIG. 6 is a block diagram of an exemplary UE 600 according to some aspects of the present disclosure. The UE 600 may be the UE 115 or the UE 120 in the network 100, 200, or 300 as discussed above. As shown, the UE 600 may include a processor 602, a memory 604, a beam failure detection module 608, a transceiver 610 including a modem subsystem 612 and a radio frequency (RF) unit 614, and one or more antennas 616. These elements may be coupled with each other and in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 604 includes a non-transitory computer-readable medium. The memory 604 may store instructions 606. The instructions 606 may include instructions that, when executed by the processor 602, cause the processor 602 to perform the operations described herein with reference to the UEs 115 in connection with aspects of the present disclosure, for example, aspects of FIGS. 2-5 and 8-9. Instructions 606 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The beam failure detection module 608 may be implemented via hardware, software, or combinations thereof. For example, the beam failure detection module 608 may be implemented as a processor, circuit, and/or instructions 606 stored in the memory 604 and executed by the processor 602. In some aspects, the beam failure detection module 608 may be used to receive a first reference signal associated with a first serving cell, measure at least one of a power delay profile (PDP) associated with the first reference signal or an angle of arrival (AOA) associated with the first reference signal, and determine a beam failure associated with a second reference signal associated with a second serving cell based on the at least one of the PDP or the AOA. The second serving cell is different from the first serving cell.

As shown, the transceiver 610 may include the modem subsystem 612 and the RF unit 614. The transceiver 610 can be configured to communicate bi-directionally with other devices, such as the BSs 105 and/or the UEs 115. The modem subsystem 612 may be configured to modulate and/or encode the data from the memory 604 and the according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together to enable the UE 600 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The antennas 616 may include multiple antennas of similar or different designs in order to sustain multiple transmission links. The RF unit 614 may configure the antennas 616.

In some instances, the UE 600 can include multiple transceivers 610 implementing different RATs (e.g., NR and LTE). In some instances, the UE 600 can include a single transceiver 610 implementing multiple RATs (e.g., NR and LTE). In some instances, the transceiver 610 can include various components, where different combinations of components can implement RATs.

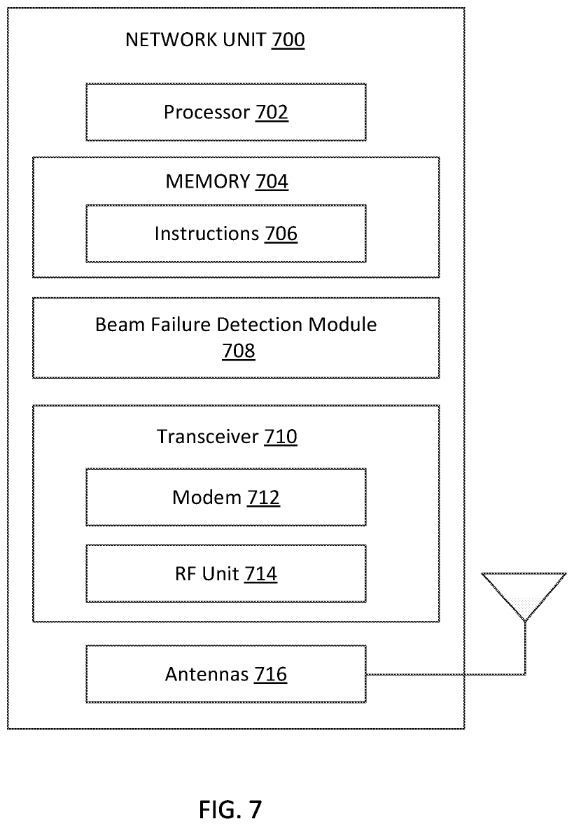

FIG. 7 is a block diagram of an exemplary network unit 700 according to some aspects of the present disclosure. The network unit 700 may be a BS 105, the CU 1210, the DU 1230, or the RU 1240, as discussed above. As shown, the network unit 700 may include a processor 702, a memory 704, a beam failure detection module 708, a transceiver 710 including a modem subsystem 712 and a RF unit 714, and one or more antennas 716. These elements may be coupled with each other and in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 2-5 and 8-9. Instructions 706 may also be referred to as code, which may be interpreted broadly to include any type of computer-readable statement(s).

The beam failure detection module 708 may be implemented via hardware, software, or combinations thereof. For example, the beam failure detection module 708 may be implemented as a processor, circuit, and/or instructions 706 stored in the memory 704 and executed by the processor 702.

In some aspects, the beam failure detection module 708 may implement the aspects of FIGS. 2-5 and 8-9. For example, the beam failure detection module 708 may transmit, to a UE (e.g., UE 115, UE 120, or UE 600), a configuration for a machine learning model, transmit a plurality of references signals, and receive a report indicating a beam failure associated with a second serving cell.

Additionally or alternatively, the beam failure detection module 708 can be implemented in any combination of hardware and software, and may, in some implementations, involve, for example, processor 702, memory 704, instructions 706, transceiver 710, and/or modem 712.

As shown, the transceiver 710 may include the modem subsystem 712 and the RF unit 714. The transceiver 710 can be configured to communicate bi-directionally with other devices, such as the UEs 115 and/or 600. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data from the modem subsystem 712 (on outbound transmissions) or of transmissions originating from another source such as a UE 115 or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the network unit 700 to enable the network unit 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, a configuration indicating a plurality of sub-slots within a slot according to aspects of the present disclosure. The antennas 716 may further receive data messages transmitted from other devices and provide the received data messages for processing and/or demodulation at the transceiver 710. The antennas 716 may include multiple antennas of similar or different designs in order to sustain multiple transmission links.

In some instances, the network unit 700 can include multiple transceivers 710 implementing different RATs (e.g., NR and LTE). In some instances, the network unit 700 can include a single transceiver 710 implementing multiple RATs (e.g., NR and LTE). In some instances, the transceiver 710 can include various components, where different combinations of components can implement RATs.

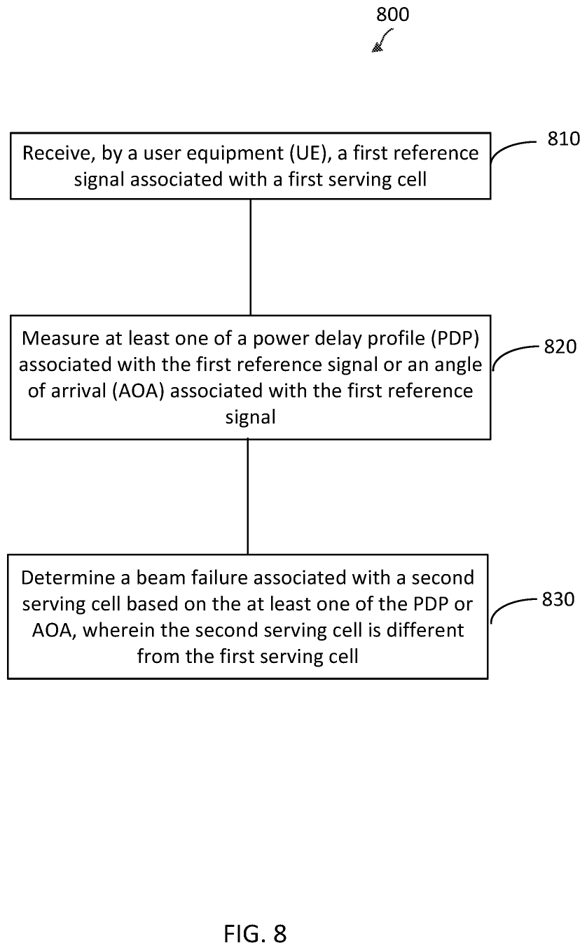

FIG. 8 is a flow diagram of a communication method 800 according to some aspects of the present disclosure. Aspects of the method 800 can be executed by a computing device (e.g., a processor, processing circuit, and/or other suitable component) of a wireless communication device or other suitable means for performing the aspects. For example, a wireless communication device, such as the UE 115, UE 120, or UE 600 may utilize one or more components to execute aspects of method 800. The method 800 may employ similar mechanisms as in the networks 100 and 200 and the aspects and actions described with respect to FIGS. 2-5. For example, a wireless communication device, such as the UE 115 or 600, may utilize one or more components, such as such as the processor 602, the memory 604, the beam failure detection module 608, the transceiver 610, the modem 612, and the one or more antennas 616, to execute aspects of the method 800. As illustrated, the method 800 includes a number of enumerated aspects, but the method 800 may include additional aspects before, after, and in between the enumerated aspects. In some aspects, one or more of the enumerated aspects may be omitted or performed in a different order.

At action 810, the method 800 includes a UE (e.g., the UE 115, UE 120, or UE 600) receiving a first reference signal associated with a first serving cell. In this regard, the UE may receive the first reference signal from a network unit (e.g., the BS 105, the CU 1210, the DU 1230, the RU 1240, and/or the network unit 700). The first reference signal may include a channel state information reference signal (CSI-RS), a synchronization signal block (SSB), and/or other reference signal. In some aspects, the first serving cell may be a serving cell operating in at least frequency range 1 (FR1). The FR1 may include frequencies in the range of about 4.1 GHz to about 7.125 GHz. In addition to or in lieu of FR1, the first serving cell may operate in one or more other frequency ranges.

At action 820, the method 800 includes the UE measuring at least one of a power delay profile (PDP) associated with the first reference signal or an angle of arrival (AOA) associated with the first reference signal. The PDP may characterize a multipath channel between the UE and the first serving cell. The UE may measure the PDP associated with the first reference signal using any suitable method. For example, the reference signal received power (RSRP) of a plurality of delay paths associated with the first reference signal may be measured and the respective propagation delay of each delay path may be determined and/or recorded.

The AOA may represent the direction of propagation of the first reference signal with respect to the UE. The UE may measure the AOA associated with the first reference signal using any suitable method. For example, the UE may measure the AOA associated with a plurality of delay paths based on a time difference of arrival and/or a received phase associated with the first reference signal. The AOA may be represented as an azimuth angle and/or an elevation angle relative to the first serving cell.

At action 830, the method 800 includes the UE determining a beam failure associated with a second reference signal associated with a second serving cell based on the first reference signal. In some instances, the UE may determine the beam failure associated with the second reference signal based on at least one of the PDP and/or the AOA. In some instances, the UE may determine the beam failure associated with the second reference signal based on the PDP using one or more of a received signal strength indicator (RSSI) associated with the first reference signal, a reference signal received power (RSRP) associated with the first reference signal, a number of delay paths associated with the first reference signal, a reference signal received quality (RSRQ) associated with the first reference signal, and/or a signal-to-noise and interference ratio (SINR) associated with the first reference signal. In some instances, the UE may determine the beam failure associated with the second reference signal based on the AOA using one or more of a time difference of arrival and/or a received phase associated with the first reference signal.

In some aspects, the second serving cell is different from the first serving cell. In this regard, the first serving cell may be a serving cell operating in at least FR1 while the second serving cell may be a serving cell operating in at least frequency range 2 (FR2). The FR2 frequency range may include frequencies in the range of about 24.25 GHz to about 52.6 GHz. In addition to or in lieu of FR1, the second serving cell may operate in one or more other frequency ranges. In some aspects, the first serving cell may be in a master cell group (MCG) and the second serving cell may be in a secondary cell group (SCG). The wireless network (e.g., wireless network 100 or 200) may operate in a dual connectivity mode in which the UE is connected to the first serving cell in a master cell group (MCG) and the second serving cell in a secondary cell group (SCG). The MCG may be a group of serving cells associated with a master eNB (MeNB) operating at FR1 frequencies and/or one or more other frequency ranges. The SCG may be a group of serving cells associated with a secondary eNB (SeNB) operating at FR2 frequencies and/or one or more other frequency ranges.

In some aspects, the UE may determine the beam failure associated with the second reference signal based on a reference signal received power (RSRP), a RSSI, a RSRQ, and/or a SINR associated with a line of sight path of the first reference signal satisfying a first threshold. The line of sight path of the first reference signal may be a direct path from the network unit to the UE (e.g., a path without multipath reflections). The RSRP of the line of sight path of the first reference signal may be included in the PDP determined at action 820. The RSRP of the line of sight path of the first reference signal may have the highest RSRP of all paths included in the PDP. The line of sight path may have the shortest delay path associated with the first reference signal. The UE may measure the RSRP associated with the line of sight path of the first reference signal as the linear average over the power contributions of the resource elements that carry the first reference signal. In some instances, the UE may determine the beam failure based on the RSRP being less than or equal to the first threshold. The first threshold may be preconfigured in the UE. Additionally or alternatively, the UE may receive an indicator indicating the first threshold from the network unit via RRC signaling or other communication.

In some aspects, the UE may determine the beam failure associated with the second reference signal based on determining a RSRP), a RSSI, a RSRQ, and/or a SINR associated with a non-line of sight (NLOS) path of the first reference signal satisfies a second threshold. The NLOS path of the first reference signal may be an indirect path from the network unit to the UE resulting from multipath reflections of the first reference signal. The UE may measure the RSRP associated with a NLOS path of the first reference signal as the linear average over the power contributions of the resource elements that carry the first reference signal over the NLOS path. In some instances, the UE may determine the beam failure based on the RSRP of the NLOS path being less than or equal to the second threshold. The second threshold may be preconfigured in the UE. Additionally or alternatively, the UE may receive an indicator indicating the second threshold from the network unit via RRC signaling or other communication.

In some aspects, the UE may determine the beam failure associated with the second reference signal based on determining a number of delay paths associated with the first reference signal that satisfy a third threshold. In this regard, the UE may identify the number of delay paths associated with the first reference signal. The number of delay paths may be identified based on the PDP at action 820. In some instances, the UE may determine the beam failure based on the number of delay paths associated with the first reference signal being greater than or equal to the third threshold. The third threshold may be preconfigured in the UE. Additionally or alternatively, the UE may receive an indicator indicating the third threshold from the network unit via RRC signaling or other communication.

In some aspects, the UE may determine the beam failure associated with the second reference signal based on the AOA associated with the first reference signal satisfying an AOA range. In this regard, the UE may determine the AOAs associated with a number of delay paths of the first reference signal within a delay window (e.g., a time duration). In some instances, the UE may determine the beam failure based on the AOAs associated with the number of delay paths of the first reference signal within the delay window being within the AOA range. In some instances, the UE may determine the beam failure associated with the second reference signal based on the AOA using one or more of a time difference of arrival and/or a received phase associated with the first reference signal. Additionally or alternatively, the UE may determine the beam failure based on the AOAs associated with the number of delay paths of the first reference signal within the delay window being outside the AOA range. In some aspects, the AOA range may be an azimuth angle range relative to the line of site path, an elevation angle range relative to the line of site path, and/or other suitable AOA range. The AOA range may be preconfigured in the UE. Additionally or alternatively, the UE may receive an indicator indicating the AOA range from the network unit via RRC signaling or other communication.

In some aspects, the UE may determine the beam failure associated with the second reference signal based on determining a block error rate (BLER) of a hypothetical physical downlink control channel (PDCCH) associated with the first reference signal satisfies a fourth threshold. The hypothetical PDCCH for BLER determination may utilize aspects of the 3GPP specification TS 36.133 in terms of downlink control information (DCI) format, aggregation level, and/or resource element (RE) energy ratio. The UE may determine the BLER based on an estimation and/or prediction of the BLER. The BLER may be a ratio of the number of blocks incorrectly received to the number of blocks correctly received by the UE. In some instances, the UE may determine the beam failure based on the BLER of the hypothetical PDCCH being greater than the fourth threshold. The fourth threshold may be preconfigured in the UE. Additionally or alternatively, the UE may receive an indicator indicating the fourth threshold from the network unit via RRC signaling or other communication.

In some aspects, the UE may determine the beam failure associated with the second reference signal based on determining a probability of the beam failure satisfies a threshold (e.g., a probability threshold). The UE may determine the probability of beam failure based on a machine learning model. The machine learning model may include an artificial neural network (e.g., a convolutional neural network, a recurrent neural network, or other suitable neural network). The machine learning model may be used with parameters associated with the first reference signal as inputs. For example, the inputs to the machine learning model may include, without limitation, the delay spread associated with the multiple paths of the first reference signal, the RSRP associated with the multiple paths of the first reference signal, the PDP associated with the first reference signal as determined at action 820, the AOA associated with the multiple paths of the first reference signal as determined at action 820, and/or the BLER of a hypothetical PDCCH associated with the first reference signal. The output of the machine learning model may be a probability of beam failure associated with the second reference signal. The probability of beam failure associated with the second reference signal may have a value between 0 and 1. The probability threshold may also have a value between 0 and 1. The UE may compare the probability value to the probability threshold. If the probability value is higher than the probability threshold, the UE determines a beam failure associated with the second reference signal. The UE may report the beam failure to the network unit as a binary indicator (e.g., beam failure or no beam failure). Additionally or alternatively, the UE may report the probability value to the network unit. The probability threshold may be preconfigured in the UE. Additionally or alternatively, the UE may receive an indicator indicating the probability threshold from the network unit via RRC signaling or other communication.

In some aspects, the UE may determine the beam failure associated with the second reference signal based on a block error rate (BLER) of a hypothetical physical downlink control channel (PDCCH) associated with the second reference signal satisfying a BLER threshold. The UE may determine the BLER of the hypothetical PDCCH based on a machine learning model. The machine learning model may include an artificial neural network (e.g., a convolutional neural network, a recurrent neural network, or other suitable neural network). The machine learning model may the same or different from the machine learning model used to determine a probability of the beam failure. The machine learning model may be used with parameters associated with the first reference signal as inputs. For example, the inputs to the machine learning model may include, without limitation, the PDP associated with the first reference signal, the AOA associated with the first reference signal, and/or the BLER of a hypothetical PDCCH associated with the first reference signal. The output of the machine learning model may be a BLER of a hypothetical PDCCH associated with the second reference signal. The UE may determine a beam failure associated with the second reference signal based on the BLER being higher than a BLER threshold. The BLER threshold may be preconfigured in the UE. Additionally or alternatively, the UE may receive an indicator indicating the BLER threshold from the network unit via RRC signaling or other communication.

In some aspects, the UE may receive a machine learning configuration from the network unit. In this regard, the UE may receive the machine learning configuration from the network unit via RRC signaling, a PDCCH communication, a PDSCH communication, or other suitable communication. The machine learning model may be configured based on the machine learning configuration. The machine learning configuration may include, without limitation, identification of ML model inputs, weights, vectors, coefficients, equations, algorithms, type of ML model, etc.

In some aspects, the UE may determine features of a plurality of first reference signals associated with the first serving cell based on a plurality of first machine learning models. The UE may determine a probability of the beam failure associated with the second reference signal based on using the features associated with the plurality of first reference signals as inputs to a second machine learning model. In other words, a plurality of first machine learning models may use a plurality of first reference signals as inputs. The outputs of the plurality of first machine learning models may be the features (e.g., PDP, AOA, RSRP, interference level, etc.) of the first reference signals. The features of the first reference signals may be inputs to a second machine learning model. The output of the second machine learning model may be a probability of beam failure associated with the second reference signal. The UE may determine a beam failure associated with the second reference signal based on the probability being higher than a probability threshold. The probability threshold may be preconfigured in the UE. Additionally or alternatively, the UE may receive an indicator indicating the probability threshold from the network unit via RRC signaling or other communication. The first machine learning model may be the same or different from the second machine learning model.

In some aspects, the UE may determine features of a plurality of first reference signals associated with the first serving cell based on a plurality of first machine learning models. The features associated with the plurality of first reference signals may be inputs to a third machine learning model. In other words, a plurality of first machine learning models may use a plurality of first reference signals as inputs. The outputs of the plurality of first machine learning models may be features (e.g., PDP, AOA, RSRP, interference level, etc.) of the first reference signals. The features of the first reference signals may be inputs to a third machine learning model. The output of the third machine learning model may be a BLER of a hypothetical PDCCH associated with the second reference signal. The UE may determine a beam failure associated with the second reference signal based on the BLER being higher than a BLER threshold. The BLER threshold may be preconfigured in the UE. Additionally or alternatively, the UE may receive an indicator indicating the BLER threshold from the network unit via RRC signaling or other communication. The first machine learning model may be the same or different from the third machine learning model.

In some aspects, the UE may transmit an indicator to the network unit. The indicator may indicate the probability of the beam failure associated with the second reference signal. The UE may report the beam failure to the network unit as a binary indicator (e.g., beam failure or no beam failure). Additionally or alternatively, the UE may report the probability value to the network unit. In this regard, the UE may transmit the indicator to the network unit via a medium access control control element (MAC-CE), uplink control information (UCI), a PUCCH communication, a PUSCH communication, or other suitable communication.

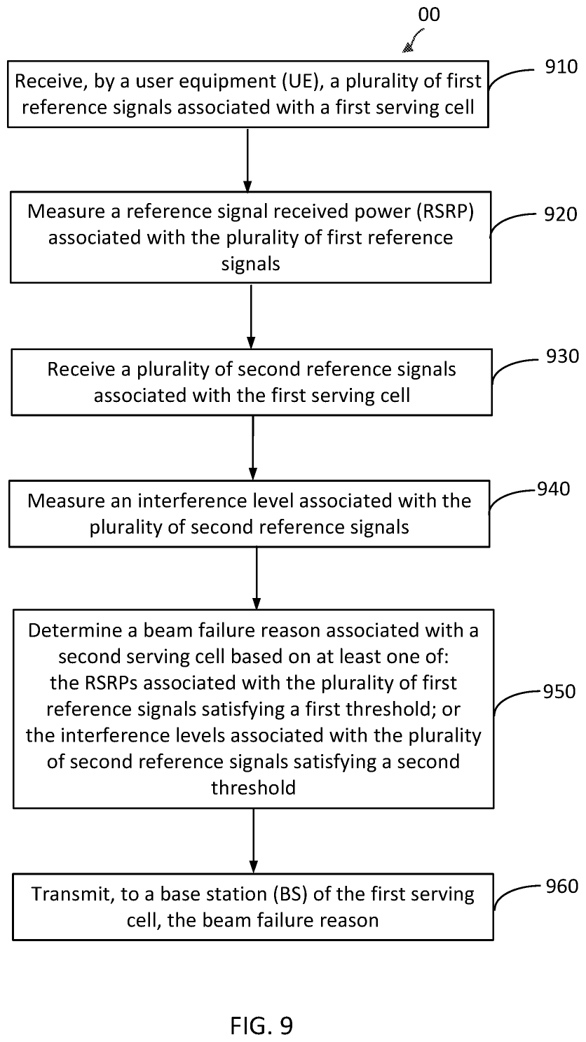

FIG. 9 is a flow diagram of a communication method 900 according to some aspects of the present disclosure. Aspects of the method 900 can be executed by a computing device (e.g., a processor, processing circuit, and/or other suitable component) of a wireless communication device or other suitable means for performing the aspects. For example, a wireless communication device, such as the UE 115, UE 120, or UE 600 may utilize one or more components to execute aspects of method 900. The method 900 may employ similar mechanisms as in the networks 100 and 200 and the aspects and actions described with respect to FIGS. 2-5. For example, a wireless communication device, such as the UE 115, UE 120, or UE 600, may utilize one or more components, such as such as the processor 602, the memory 604, the beam failure detection module 608, the transceiver 610, the modem 612, and the one or more antennas 616, to execute aspects of the method 900. As illustrated, the method 900 includes a number of enumerated aspects, but the method 900 may include additional aspects before, after, and in between the enumerated aspects. In some aspects, one or more of the enumerated aspects may be omitted or performed in a different order.

At action 910, the method 900 includes a UE (e.g., the UE 115, UE 120, or UE 600) receiving a plurality of first reference signals associated with a first serving cell. In this regard, the UE may receive the plurality of first reference signals from a network unit (e.g., the BS 105, the CU 1210, the DU 1230, the RU 1240, and/or network unit 700 The plurality of first reference signals may include channel state information reference signals (CSI-RSs), a synchronization signal blocks (SSBs), and/or other reference signals. In some aspects, the first serving cell may be a serving cell operating in at least frequency range 1 (FR1). The FR1 may include frequencies in the range of about 4.1 GHz to about 7.125 GHz. In addition to or in lieu of FR1, the first serving cell may operate in one or more other frequency ranges.

At action 920, the method 900 includes a UE measuring a reference signal received power (RSRP) associated with the plurality of first reference signals, a received signal strength indicator (RSSI) associated with the plurality of first reference signals, a number of delay paths associated with the plurality of first reference signals, a reference signal received quality (RSRQ) associated with the plurality of first reference signals, and/or a signal-to-noise and interference ratio (SINR) associated with the plurality of first reference signals. In this regard, the UE may measure the RSRP associated with the plurality of first reference signals as the linear average over the power contributions of the resource elements that carry the plurality of first reference signals.

At action 930, the method 900 includes a UE (e.g., the UE 115, UE 120, or UE 600) receiving a plurality of second reference signals associated with the first serving cell. In this regard, the UE may receive the plurality of second reference signals from a network unit (e.g., the BS 105, the CU 1210, the DU 1230, the RU 1240, and/or network unit 700). The plurality of second reference signals may include channel state information reference signals (CSI-RSs), a synchronization signal blocks (SSBs), and/or other reference signals. The plurality of second reference signals may include zero power (ZP-CSI-RSs).

At action 940, the method 900 includes a UE measuring an interference level associated with the plurality of second reference signals. The interference measurement may be indicated as a power level (e.g., in units of dBm) and/or as a relative measurement in units of decibels (e.g., relative to the RSRP of the first reference signal and/or the second reference signal). The plurality of second reference signals may be configured as zero power (ZP-CSI-RS). The plurality of ZP-CSI-RSs may enable the UE to measure interference levels from interference sources. The zero power CSI-RSs may contribute no interference to the interference measurement allowing the interference measurements to determine the level of interference from other sources include interference from transmissions by other UEs, transmissions by other serving cells, and interference from other radio frequency producing devices.

At action 950, the method 900 includes a UE determining a beam failure reason associated with a third reference signal configured in a second serving cell. The beam failure reason may include a signal and/or interference measurement satisfying a threshold. The first serving cell may be a serving cell operating in at least FR1 while the second serving cell may be a serving cell operating in at least frequency range 2 (FR2). In some aspects, the UE may determine the beam failure reason associated with the third reference signal based on the RSRPs associated with the plurality of first reference signals satisfying a first threshold. For example, the UE may determine the beam failure reason associated with the third reference signal based on the RSRPs associated with the plurality of first reference signals being less than or equal to the first threshold.

In some aspects, the UE may determine the beam failure reason associated with the third reference signal based on the interference levels associated with the plurality of second reference signals satisfying a second threshold. For example, the UE may determine the beam failure reason associated with the third reference signal based on the interference level associated with the second reference signals being greater than the second threshold. The first threshold may be different from the second threshold. The beam failure reason associated with the third reference signal may be based on the RSRPs associated with the plurality of first reference signals satisfying a first threshold and/or the interference level associated with the second reference signals being greater than the second threshold.

At action 960, the method 900 includes a UE transmitting an indication of the beam failure reason to a network unit (e.g., the BS 105, the CU 1210, the DU 1230, the RU 1240, and/or the network unit 700) of the first serving cell. In this regard, the UE may transmit the indication of the beam failure reason to the network unit via a medium access control-control element (MAC-CE), a physical uplink control channel (PUCCH) scheduling request (SR), or other suitable communication. The UE may indicate the beam failure reason using any suitable format, including without limitation a bitmap, a table, a numerical value, and/or other data structure.

In some aspects, the UE may transmit the indication of the beam failure reason via a candidate reference signal identifier of a first list of candidate reference signal identifiers associated with RSRP measurements in the second serving cell. In this regard, the UE may be configured with a list of candidate reference signal identifiers that correspond to an associated beam failure reason. Accordingly, in some instances the UE may utilize the candidate reference signal identifier(s) associated with a particular beam failure reason to indicate the beam failure reason. The UE may report the beam failure reason by transmitting the candidate reference signal identifier(s) in the MAC-CE that correspond to the determined beam failure reason. For example, a list of candidate reference signal identifiers associated with the first serving cell may be used to indicate a beam failure reason based on RSRPs associated with the plurality of first reference signals being less than or equal to the first threshold. For another example, a list of candidate reference signal identifiers associated with the second serving cell may be used to indicate a beam failure reason based on the interference level associated with the second reference signals being greater than the second threshold.

In some aspects, the UE may transmit an indicator to the network unit indicating the probability of the beam failure reason. The probability of the beam failure reason may be based on the RSRPs associated with the plurality of first reference signals being less than or equal to the first threshold and/or the interference levels associated with the second reference signals being greater than the second threshold. In this regard, the UE may transmit the indicator indicating the probability of the beam failure reason via a MAC-CE, UCI, a PUCCH communication, or other suitable communication. The UE may indicate the probability of the beam failure reason using any suitable format, including without limitation a bitmap, a table, a numerical value, and/or other data structure.

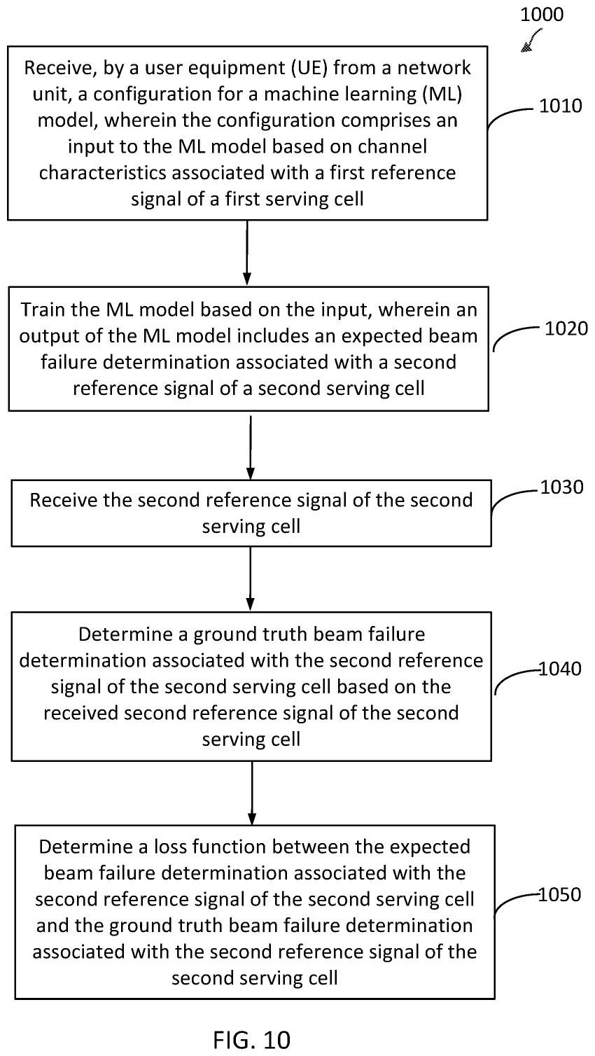

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the aspects. For example, a wireless communication device, such as the UE 115, UE 120, or UE 600 may utilize one or more components to execute aspects of method 1000. The method 1000 may employ similar mechanisms as in the networks 100 and 200 and the aspects and actions described with respect to FIGS. 2-5. For example, a wireless communication device, such as the UE 115, UE 120, or UE 600, may utilize one or more components, such as such as the processor 602, the memory 604, the beam failure detection module 608, the transceiver 610, the modem 612, and the one or more antennas 616, to execute aspects of the method 1000. As illustrated, the method 1000 includes a number of enumerated aspects, but the method 1000 may include additional aspects before, after, and in between the enumerated aspects. In some aspects, one or more of the enumerated aspects may be omitted or performed in a different order.

At action 1010, the method 1000 includes a UE (e.g., the UE 115, UE 120, or UE 600) receiving a configuration for a machine learning (ML) model from a network unit (e.g., the BS 105, the CU 1210, the DU 1230, the RU 1240, and/or the network unit 700). In this regard, the UE may receive the configuration via RRC signaling or other suitable communication. The configuration may comprise an input to the ML model based on channel characteristics associated with a first reference signal of a first serving cell. The first reference signal may include a channel state information reference signal (CSI-RS), a synchronization signal block (SSB), and/or other suitable reference signal. In some aspects, the first serving cell may be a serving cell operating in at least frequency range 1 (FR1). The machine learning model may include an artificial neural network (e.g., a convolutional neural network, a recurrent neural network, or other suitable neural network). In some aspects, the channel characteristics associated with the first reference signal of the first serving cell may include a power delay profile (PDP) or an angle of arrival (AOA) associated with the first reference signal. The PDP may characterize the multipath channel between the UE and the first serving cell. The UE may measure the PDP associated with the first reference signal using any suitable method. For example, the reference signal received power (RSRP), a RSSI, a RSRQ, and/or a SINR of a plurality of delay paths associated with the first reference signal may be measured and the respective propagation delay of each delay path may be recorded. In some instances, the UE may determine the beam failure associated with the second reference signal based on the PDP using one or more of a received signal strength indicator (RSSI) associated with the first reference signal, a reference signal received power (RSRP) associated with the first reference signal, a number of delay paths associated with the first reference signal, a reference signal received quality (RSRQ) associated with the first reference signal, and/or a signal-to-noise and interference ratio (SINR) associated with the first reference signal. The AOA may represent the direction of propagation of the first reference signal with respect to the UE. The UE may measure the AOA associated with the first reference signal using any suitable method. For example, the UE may measure the AOA associated with a plurality of delay paths based on a time difference of arrival and/or a received phase associated with the first reference signal. The AOA may be represented as an azimuth angle and/or an elevation angle relative to the first serving cell.

At action 1020, the method 1000 includes a UE training the ML model based on the inputs. The output of the ML model may include an expected beam failure determination associated with a second reference signal of a second serving cell. The UE may train the ML model to increase the accuracy of determining (e.g., predicting) a beam failure associated with the second reference signal of the second serving cell. The PDP and/or the AOA associated with the first reference signal may be used as training data inputs to the ML model. The output of the ML model may be a probability of beam failure associated with the second reference signal of the second serving cell. The probability of beam failure associated with the second reference signal may have a value between 0 and 1. The probability threshold may also have a value between 0 and 1. The UE may compare the probability value to the probability threshold. If the probability value is higher than the probability threshold, the UE determines a beam failure associated with the second reference signal. The UE may report the beam failure to the network unit as a binary indicator (e.g., beam failure or no beam failure). Additionally or alternatively, the UE may report the probability value to the network unit.

At action 1030, the method 1000 includes a UE receiving the second reference signal of the second serving cell. In this regard, the UE may receive the second reference signal from a network unit (e.g., the BS 105, the CU 1210, the DU 1230, the RU 1240, and/or network unit 700) via RRC signaling or other communication. The second reference signal may be a CSI-RS, a SSB, and/or other suitable reference signal received by the UE in an FR2 frequency band. The UE may receive the second reference signal based on a spatial filter. In this regard, the UE may receive the second reference signal based on the same spatial filter used to determine the channel characteristics associated with the first reference signal. For example, the UE may be configured by the network unit such that the second reference signal is quasi-colocated (QCL) with the first reference signal (e.g., type D QCL).

At action 1040, the method 1000 includes a UE determining a ground truth beam failure determination associated with the second reference signal of the second serving cell based on the received second reference signal of the second serving cell. The UE may determine the beam failure based on ground truth data. The ground truth data may be the parameters of the received second reference signal (e.g., RSSI, RSRQ, SINR, RSRP, interference level, BLER of a hypothetical PDCCH, PDP, AOA, etc.) generated by the UE based on measurements of the second reference signal in the second serving cell.

At action 1050, the method 1000 includes a UE determining a loss function between the expected beam failure determination associated with the second reference signal of the second serving cell and the ground truth beam failure determination associated with the second reference signal of the second serving cell. The loss function may represent a discrepancy (e.g., an error) between the beam failure determination based on the ground truth data associated with the received second reference signal and the expected beam failure (e.g., predicted beam failure) based on the channel characteristics associated with a first reference signal. The UE may train the ML model to minimize the loss function and/or increase the accuracy of predicting a beam failure associated with the second reference signal.

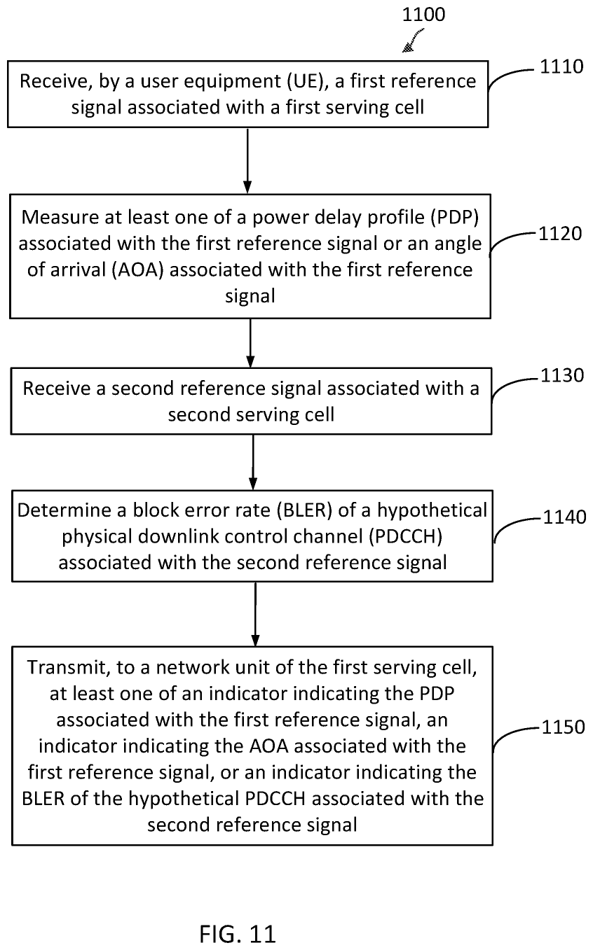

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the aspects. For example, a wireless communication device, such as the UE 115, UE 120, or UE 600 may utilize one or more components to execute aspects of method 1100. The method 1100 may employ similar mechanisms as in the networks 100 and 200 and the aspects and actions described with respect to FIGS. 2-5. For example, a wireless communication device, such as the UE 115, UE 120, or UE 600, may utilize one or more components, such as such as the processor 602, the memory 604, the beam failure detection module 608, the transceiver 610, the modem 612, and the one or more antennas 616, to execute aspects of the method 1100. As illustrated, the method 1100 includes a number of enumerated aspects, but the method 1100 may include additional aspects before, after, and in between the enumerated aspects. In some aspects, one or more of the enumerated aspects may be omitted or performed in a different order.

At action 1110, the method 1100 includes a UE (e.g., the UE 115, UE 120, or UE 600) receiving a first reference signal associated with a first serving cell. In this regard, the UE may receive the first reference signal associated with the first serving cell from a network unit (e.g., the BS 105, the CU 1210, the DU 1230, the RU 1240, and/or the network unit 700). The first reference signal may be a CSI-RS, r a SSB, and/or other reference signal received by the UE in an FR1 frequency band.

At action 1120, the method 1100 includes a UE measuring at least one of a power delay profile (PDP) associated with the first reference signal or an angle of arrival (AOA) associated with the first reference signal. The PDP may characterize the multipath channel between the UE and the first serving cell. The UE may measure the PDP associated with the first reference signal using any suitable method. For example, the reference signal received power (RSRP), RSSI, RSRQ, and/or SINR of a plurality of delay paths associated with the first reference signal may be measured and the respective propagation delay of each delay path may be recorded. In some instances, the UE may determine the beam failure associated with the second reference signal based on the PDP using one or more of a received signal strength indicator (RSSI) associated with the first reference signal, a reference signal received power (RSRP) associated with the first reference signal, a number of delay paths associated with the first reference signal, a reference signal received quality (RSRQ) associated with the first reference signal, and/or a signal-to-noise and interference ratio (SINR) associated with the first reference signal. The AOA may represent the direction of propagation of the first reference signal with respect to the UE. The UE may measure the AOA associated with the first reference signal using any suitable method. For example, the UE may measure the AOA associated with a plurality of delay paths based on a time difference of arrival and/or a received phase associated with the first reference signal. The AOA may be represented as an azimuth angle and/or an elevation angle relative to the first serving cell.

At action 1130, the method 1100 includes a UE (e.g., the UE 115, UE 120, or UE 600) receiving a second reference signal associated with a second serving cell. In this regard, the UE may receive the second reference signal associated with the second serving cell from a network unit (e.g., the BS 105, the CU 1210, the DU 1230, the RU 1240, and/or network unit 700). The second reference signal may be a CSI-RS, a SSB, and/or other reference signal received by the UE in an FR2 frequency band.

At action 1140, the method 1100 includes a UE determining a block error rate (BLER) of a hypothetical physical downlink control channel (PDCCH) associated with the second reference signal. The hypothetical PDCCH for BLER determination may be defined in the 3GPP specification TS 36.133 in terms of downlink control information (DCI) format, aggregation level, and resource element (RE) energy ratio. The UE may determine the BLER based on an estimation and/or prediction of the BLER. The BLER may be a ratio of the number of blocks incorrectly received to the number of blocks correctly received by the UE.

At action 1150, the method 1100 includes a UE transmitting an indicator to a network unit of the first serving cell. In this regard, the UE may transmit the indicator to the network unit via at least one channel state information (CSI) report or other suitable communication. The UE may transmit the indicator to the network unit via at least one CSI report periodically or aperiodically. For example, the UE may transmit the at least one CSI report periodically via a PUCCH and/or aperiodically via a PUSCH or other suitable communication.

In some aspects, the indicator may indicate the PDP associated with the first reference signal. The PDP indicator may include the RSRP, RSSI, RSRQ, and/or SINR of a plurality of delay paths associated with the first reference signal and the respective propagation delay of each delay path. In some aspects, the indicator may indicate the AOA associated with the first reference signal. The AOA indicator may include the AOA (e.g., azimuth angle and/or an elevation angle relative to the first serving cell) associated with a plurality of delay paths associated with the first reference signal. In some aspects, the indicator may indicate the BLER of the hypothetical PDCCH associated with the second reference signal. The BLER indicator may be reported as a ratio (e.g., a percentage), an indicator relative to a beam out of sync threshold (e.g., Qout), and/or an indicator relative to a beam in sync threshold (e.g., Qin).

In some aspects, the UE may receive an indicator from the network unit indicating a spatial filter. In this regard, the UE may receive the spatial filter indicator from the network unit via RRC messaging, DCI, or other suitable communication. The spatial filter indicator may indicate a QCL type D. In some aspects, the location of a first antenna port of the UE may be different from the location of a second antenna port of the UE. QCL type D may indicate to the UE that the channel properties associated with the second reference signal received at the first antenna port of the UE may be inferred by the channel properties of the first reference signal received at the second antenna port. In some aspects, the spatial filter indicator may include a transmission configuration indicator (TCI) state. The TCI state may indicate the QCL-relationships between the first reference signal, the second reference signal, and the antenna ports of the UE.

Further aspects of the present disclosure include the following:

Aspect 1 includes a method of wireless communication performed by a user equipment (UE), the method comprising receiving a first reference signal associated with a first serving cell; measuring at least one of a power delay profile (PDP) associated with the first reference signal or an angle of arrival (AOA) associated with the first reference signal; and determining a beam failure associated with a second serving cell based on the at least one of the PDP or the AOA, wherein the second serving cell is different from the first serving cell.

Aspect 2 includes the method of aspect 1 the receiving the first reference signal associated with the first serving cell comprises receiving the first reference signal in a frequency range 1 (FR1); and the determining the beam failure associated with the second serving cell comprises determining the beam failure in a frequency range 2 (FR2).

Aspect 3 includes the method of any of aspects 1-2, wherein: the determining the beam failure associated with the second serving cell comprises at least one of: determining a reference signal received power (RSRP) associated with a line of sight path of the first reference signal satisfies a first threshold; determining a RSRP associated with a non-line of sight path of the first reference signal satisfies a second threshold; determining a number of identified paths associated with the first reference signal satisfies a third threshold; determining the AOA associated with the first reference signal satisfies an AOA range; or determining a hypothetical physical downlink control channel (PDCCH) block error rate (BLER) associated with the first reference signal satisfies a fourth threshold.

Aspect 4 includes the method of any of aspects 1-3, wherein: the determining the beam failure associated with the second serving cell comprises at least one of: determining, based on a machine learning model, a probability of the beam failure satisfies a first threshold; or determining, based on the machine learning model, a hypothetical physical downlink control channel (PDCCH) block error rate (BLER) associated with the first reference signal satisfies a second threshold.

Aspect 5 includes the method of any of aspects 1-4, further comprising: receiving, from a network unit, a machine learning configuration, wherein the machine learning model is configured based on the machine learning configuration.

Aspect 6 includes the method of any of aspects 1-5, wherein: the measuring at least one of the PDP associated with the first reference signal or the AOA associated with the first reference signal comprises the measuring the PDP associated with the first reference signal, wherein the measuring the PDP associated with the first reference signal comprises measuring a delay spread and a reference signal received power (RSRP) of a plurality of delay paths associated with the first reference signal; and the determining the beam failure associated with the second serving cell comprises determining, based on the machine learning model, the probability of the beam failure satisfies the first threshold, wherein the probability of the beam failure is based on the delay spread and the RSRP of the plurality of delay paths being inputs to the machine learning model.

Aspect 7 includes the method of any of aspects 1-6, wherein: the measuring at least one of the PDP associated with the first reference signal or the AOA associated with the first reference signal comprises the measuring the AOA associated with the first reference signal, wherein the measuring the AOA associated with the first reference signal comprises measuring the AOA of a plurality of delay paths associated with the first reference signal; and the determining the beam failure associated with the second serving cell comprises determining, based on the machine learning model, the probability of the beam failure satisfies the first threshold, wherein the probability of the beam failure is based on the AOA of the plurality of delay paths being inputs to the machine learning model.

Aspect 8 includes the method of any of aspects 1-7, wherein: the determining the probability of the beam failure comprises determining, based on the machine learning model, a BLER of a hypothetical PDCCH associated with the first reference signal as input to the machine learning model.

Aspect 9 includes the method of any of aspects 1-8, further comprising determining features of a plurality of first reference signals associated with the first serving cell based on a plurality of first machine learning models, wherein: the determining the beam failure associated with the second reference signal comprises at least one of: determining, based on the features associated with the plurality of first reference signals as inputs to a second machine learning model, a probability of the beam failure satisfies a first threshold; or determining, based on the features associated with the plurality of first reference signals as inputs to a third machine learning model, a block error rate (BLER) of a hypothetical physical downlink control channel (PDCCH) associated with the second reference signal satisfies a second threshold.

Aspect 10 includes the method of any of aspects 1-9, further comprising: transmitting, to a network unit of the first serving cell, an indicator indicating the probability of the beam failure.

Aspect 11 includes the method of any of aspects 1-10, wherein the first serving cell is in a master cell group (MCG) and the second serving cell is in a secondary cell group (SCG).

Aspect 12 includes method of wireless communication performed by a user equipment (UE), the method comprising receiving a plurality of first reference signals associated with a first serving cell; measuring a reference signal received power (RSRP) associated with the plurality of first reference signals; receiving a plurality of second reference signals associated with the first serving cell; measuring an interference level associated with the plurality of second reference signals; determining a beam failure reason associated with a third reference signal configured in a second serving cell based on at least one of: the RSRPs associated with the plurality of first reference signals satisfying a first threshold; or the interference levels associated with the plurality of second reference signals satisfying a second threshold; and transmitting, to a network unit of the first serving cell, an indication of the beam failure reason.

Aspect 13 includes the method of aspect 12, wherein at least one of: the RSRPs associated with the plurality of first reference signals satisfying the first threshold comprises the RSRPs being less than or equal to the first threshold; or the interference level associated with the second reference signals satisfying the second threshold comprises the interference level associated with the second reference signals being greater than the second threshold.

Aspect 14 includes the method of any of aspects 12-13, wherein the transmitting the indication of the beam failure reason associated with the third reference signal comprises transmitting the indication of the beam failure reason via at least one of: a medium access control-control element (MAC-CE); or a physical uplink control channel (PUCCH) scheduling request (SR).

Aspect 15 includes the method of any of aspects 12-14, wherein the transmitting the indication of the beam failure reason comprises transmitting the indication of the beam failure reason via at least one of: a candidate reference signal identifier of a first list of candidate reference signal identifiers associated with RSRP measurements in the second serving cell; or a candidate reference signal identifier of a second list of candidate reference signal identifiers associated with interference measurements in the second serving cell.

Aspect 16 includes the method of any of aspects 12-15, further comprising: transmitting, to the network unit of the first serving cell, a probability of the beam failure, wherein the probability of the beam failure is based on at least one of: the RSRPs associated with the plurality of first reference signals; or the interference levels associated with the plurality of second reference signals.

Aspect 17 includes method of wireless communication performed by a user equipment (UE), the method comprising receiving, from a network unit, a configuration for a machine learning (ML) model, wherein the configuration comprises an input to the ML model based on channel characteristics associated with a first reference signal of a first serving cell; training the ML model based on the input, wherein an output of the ML model includes an expected beam failure determination associated with a second reference signal of a second serving cell; receiving the second reference signal of the second serving cell; determining a ground truth beam failure determination associated with the second reference signal of the second serving cell based on the received second reference signal of the second serving cell; and determining a loss function between the expected beam failure determination associated with the second reference signal of the second serving cell and the ground truth beam failure determination associated with the second reference signal of the second serving cell.

Aspect 18 includes the method of aspect 17, wherein the channel characteristics includes at least one of a power delay profile (PDP) or an angle of arrival (AOA) associated with the first reference signal of the first serving cell.

Aspect 19 includes the method of any of aspects 17-18, wherein: the channel characteristics associated with the first reference signal of the first serving cell are based on a spatial filter; and the determining the ground truth beam failure determination associated with the second reference signal of the second serving cell is based on the spatial filter.

Aspect 20 includes method of wireless communication performed by a user equipment (UE), the method comprising receiving, from a network unit, a configuration for a machine learning (ML) model, wherein the configuration comprises inputs to the ML model based on a reference signal received power (RSRP) associated with a first reference signal of a first serving cell and an interference level associated with a second reference signal of the first serving cell; training the ML model based on the input, wherein an output of the ML model includes at least one of an RSRP associated with a second reference signal of a second serving cell, an interference level associated with the second reference signal, or an expected beam failure determination reason associated with the second reference signal; receiving the second reference signal of the second serving cell; determining a ground truth beam failure determination reason associated with the second reference signal of the second serving cell based on at least one of the RSRP associated with the second reference signal of the second serving cell, an interference level associated with a third reference signal of the second serving cell, or the expected beam failure determination reason; and determining a loss function between the expected beam failure determination reason associated with the second reference signal of the second serving cell and the ground truth beam failure determination reason associated with the second reference signal of the second serving cell.

Aspect 21 includes the method of aspect 20, wherein the configuration further comprises at least one of an RSRP threshold or an interference level threshold; and the determining the ground truth beam failure determination associated with the second reference signal of the second serving cell is based on at least one of the RSRP associated with the second reference signal of the second serving cell satisfying the RSRP threshold or the interference level associated with the third reference signal of the second serving cell satisfying the interference level threshold.

Aspect 22 includes a method of wireless communication performed by a user equipment (UE), the method comprising receiving a first reference signal associated with a first serving cell; measuring at least one of a power delay profile (PDP) associated with the first reference signal or an angle of arrival (AOA) associated with the first reference signal; receiving a second reference signal associated with a second serving cell; determining a block error rate (BLER) of a hypothetical physical downlink control channel (PDCCH) associated with the second reference signal; and transmitting, to a network unit of the first serving cell, at least one of: an indicator indicating the PDP associated with the first reference signal; an indicator indicating the AOA associated with the first reference signal; or an indicator indicating the BLER of the hypothetical PDCCH associated with the second reference signal.

Aspect 23 includes the method of aspect 22, wherein the transmitting to the network unit comprises transmitting to the network unit via at least one channel state information (CSI) report.

Aspect 24 includes the method of any of aspects 22-23, further comprising: determining, based on the BLER of the hypothetical PDCCH associated with the second reference signal, a beam failure associated with the second serving cell; and transmitting, to the network unit of the first serving cell via at least one channel state information (CSI) report, an indicator indicating the beam failure.

Aspect 25 includes the method of any of aspects 22-24, further comprising: receiving, from the network unit of the first serving cell, an indicator indicating a spatial filter, wherein: the receiving the first reference signal associated with the first serving cell comprises receiving the first reference signal based on the spatial filter; and the receiving the second reference signal associated with the second serving cell comprises receiving the second reference signal based on the spatial filter.

Aspect 26 includes the method of any of aspects 22-25, wherein the spatial filter is based on at least one of: a transmission configuration indicator (TCI) state; or quasi co-location type D.

Aspect 27 includes a non-transitory computer-readable medium storing one or more instructions for wireless communication, the one or more instructions comprising one or more instructions that, when executed by one or more processors of a user equipment (UE), cause the UE to perform any one of aspects 1-11.

Aspect 28 includes a non-transitory computer-readable medium storing one or more instructions for wireless communication, the one or more instructions comprising one or more instructions that, when executed by one or more processors of a user equipment (UE), cause the UE to perform any one of aspects 12-16.

Aspect 29 includes a non-transitory computer-readable medium storing one or more instructions for wireless communication, the one or more instructions comprising one or more instructions that, when executed by one or more processors of a user equipment (UE), cause the UE to perform any one of aspects 17-19.

Aspect 30 includes a non-transitory computer-readable medium storing one or more instructions for wireless communication, the one or more instructions comprising one or more instructions that, when executed by one or more processors of a user equipment (UE), cause the UE to perform any one of aspects 20-21.

Aspect 31 includes a non-transitory computer-readable medium storing one or more instructions for wireless communication, the one or more instructions comprising one or more instructions that, when executed by one or more processors of a user equipment (UE), cause the UE to perform any one of aspects 22-26.

Aspect 32 includes a user equipment (UE) comprising one or more means to perform any one or more of aspects 1-11.

Aspect 33 includes a user equipment (UE) comprising one or more means to perform any one or more of aspects 12-16.

Aspect 34 includes a user equipment (UE) comprising one or more means to perform any one or more of aspects 17-19.

Aspect 35 includes a user equipment (UE) comprising one or more means to perform any one or more of aspects 20-21.

Aspect 36 includes a user equipment (UE) comprising one or more means to perform any one or more of aspects 22-26.

Aspect 38 includes a user equipment (UE) comprising a memory, a transceiver and at least one processor coupled to the memory and the transceiver, wherein the UE is configured to perform any one or more of aspects 1-11.

Aspect 39 includes a user equipment (UE) comprising a memory, a transceiver and at least one processor coupled to the memory and the transceiver, wherein the UE is configured to perform any one or more of aspects 12-16.

Aspect 40 includes a user equipment (UE) comprising a memory, a transceiver and at least one processor coupled to the memory and the transceiver, wherein the UE is configured to perform any one or more of aspects 17-19.

Aspect 41 includes a user equipment (UE) comprising a memory, a transceiver and at least one processor coupled to the memory and the transceiver, wherein the UE is configured to perform any one or more of aspects 20-21.

Aspect 42 includes a user equipment (UE) comprising a memory, a transceiver and at least one processor coupled to the memory and the transceiver, wherein the UE is configured to perform any one or more of aspects 22-26.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

1. A user equipment (UE) comprising:
a memory;
a transceiver; and
at least one processor coupled to the memory and the transceiver, wherein the UE is configured to:
receive a first reference signal associated with a first serving cell;
measure at least one of a power delay profile (PDP) associated with the first reference signal or an angle of arrival (AOA) associated with the first reference signal; and
determine a beam failure associated with a second reference signal associated with a second serving cell based on the at least one of the PDP or the AOA, wherein the second serving cell is different from the first serving cell.

2. The UE of claim 1, wherein the UE is further configured to:
receive the first reference signal in a frequency range 1 (FR1); and
determine the beam failure in a frequency range 2 (FR2).

3. The UE of claim 1, wherein the UE is further configured to:
determine the beam failure associated with the second reference signal based on at least one of:
a reference signal received power (RSRP) associated with a line of sight path of the first reference signal satisfying a first threshold;
a RSRP associated with a non-line of sight path of the first reference signal satisfying a second threshold;
a number of identified paths associated with the first reference signal satisfying a third threshold;
the AOA associated with the first reference signal satisfying an AOA range; or
a block error rate (BLER) of a hypothetical physical downlink control channel (PDCCH) associated with the first reference signal satisfying a fourth threshold.

4. The UE of claim 1, wherein the UE is further configured to:
determine the beam failure associated with the second reference signal based on at least one of:
a probability of the beam failure satisfying a first threshold based on a machine learning model; or
a block error rate (BLER) of a hypothetical physical downlink control channel (PDCCH) associated with the second reference signal satisfying a second threshold based on the machine learning model.

5. The UE of claim 4, wherein the UE is further configured to:
receive, from a network unit, a machine learning configuration, wherein the machine learning model is configured based on the machine learning configuration.

6. The UE of claim 4, wherein the UE is further configured to:
measure the PDP associated with the first reference signal, wherein the measuring the PDP associated with the first reference signal comprises measuring a delay spread and a reference signal received power (RSRP) of a plurality of delay paths associated with the first reference signal; and
determine, based on the machine learning model, the probability of the beam failure satisfies the first threshold, wherein the probability of the beam failure is based on the delay spread and the RSRP of the plurality of delay paths being inputs to the machine learning model.

7. The UE of claim 4, wherein the UE is further configured to:
measure the AOA associated with the first reference signal, wherein the measuring the AOA associated with the first reference signal comprises measuring the AOA of a plurality of delay paths associated with the first reference signal; and
determine, based on the machine learning model, the probability of the beam failure satisfies the first threshold, wherein the probability of the beam failure is based on the AOA of the plurality of delay paths being inputs to the machine learning model.

8. The UE of claim 4, wherein the UE is further configured to:
determine, based on the machine learning model, a BLER of a hypothetical PDCCH associated with the first reference signal as input to the machine learning model.

9. The UE of claim 1, wherein the UE is further configured to:
determine features of a plurality of first reference signals associated with the first serving cell based on a plurality of first machine learning models, wherein:
the UE configured to determine the beam failure associated with the second reference signal is further configured to at least one of:
determine, based on the features associated with the plurality of first reference signals as inputs to a second machine learning model, a probability of the beam failure satisfies a first threshold; or
determine, based on the features associated with the plurality of first reference signals as inputs to a third machine learning model, a hypothetical physical downlink control channel (PDCCH) block error rate (BLER) associated with the second reference signal satisfies a second threshold.

10. The UE of claim 4, wherein the UE is further configured to:
transmit, to a network unit of the first serving cell, an indicator indicating the probability of the beam failure.

11. The UE of claim 10, wherein the UE is further configured to:
transmit, to the network unit of the first serving cell, the indicator indicating the probability of the beam failure via at least one of a physical uplink control channel (PUCCH) or a physical uplink shared channel (PUSCH).

12. The UE of claim 1, wherein the first serving cell is in a master cell group (MCG) and the second serving cell is in a secondary cell group (SCG).

13. A user equipment (UE) comprising:
a memory;
a transceiver; and
at least one processor coupled to the memory and the transceiver, wherein the UE is configured to:
receive a plurality of first reference signals associated with a first serving cell;
measure a reference signal received power (RSRP) associated with the plurality of first reference signals;
receive a plurality of second reference signals associated with the first serving cell;
measure an interference level associated with the plurality of second reference signals;
determine a beam failure reason associated with a third reference signal configured in a second serving cell based on at least one of:
the RSRPs associated with the plurality of first reference signals satisfying a first threshold; or
the interference levels associated with the plurality of second reference signals satisfying a second threshold; and
transmit, to a network unit of the first serving cell, an indication of the beam failure reason.

14. The UE of claim 13, wherein at least one of:
the RSRPs associated with the plurality of first reference signals satisfying the first threshold comprises the RSRPs being less than or equal to the first threshold; or
the interference level associated with the second reference signals satisfying the second threshold comprises the interference level associated with the second reference signals being greater than the second threshold.

15. The UE of claim 13, wherein the UE is further configured to:
transmit the indication of the beam failure reason via at least one of:
a medium access control-control element (MAC-CE); or
a physical uplink control channel (PUCCH) scheduling request (SR).

16. The UE of claim 13, wherein the UE is further configured to:
transmit the indication of the beam failure reason via at least one of:
a candidate reference signal identifier of a first list of candidate reference signal identifiers associated with RSRP measurements in the second serving cell; or
a candidate reference signal identifier of a second list of candidate reference signal identifiers associated with interference measurements in the second serving cell.

17. The UE of claim 13, wherein the UE is further configured to:
transmit, to the network unit of the first serving cell, a probability of the beam failure, wherein the probability of the beam failure is based on at least one of:
the RSRPs associated with the plurality of first reference signals; or
the interference levels associated with the plurality of second reference signals.

18. The UE of claim 13, wherein the UE is further configured to:
receive the plurality of first reference signals in a frequency range 1 (FR1); and
determine the beam failure reason in a frequency range 2 (FR2).

19. A user equipment (UE) comprising:
a memory;
a transceiver; and
at least one processor coupled to the memory and the transceiver, wherein the UE is configured to:
receive, from a network unit, a configuration for a machine learning (ML) model, wherein the configuration comprises an input to the ML model based on channel characteristics associated with a first reference signal of a first serving cell;
train the ML model based on the input, wherein an output of the ML model includes an expected beam failure determination associated with a second reference signal of a second serving cell;
receive the second reference signal of the second serving cell;
determine a ground truth beam failure determination associated with the second reference signal of the second serving cell based on the received second reference signal of the second serving cell; and
determine a loss function between the expected beam failure determination associated with the second reference signal of the second serving cell and the ground truth beam failure determination associated with the second reference signal of the second serving cell.

20. The UE of claim 19, wherein the channel characteristics includes at least one of a power delay profile (PDP) or an angle of arrival (AOA) associated with the first reference signal of the first serving cell.

21. The UE of claim 19, wherein:
the channel characteristics associated with the first reference signal of the first serving cell are based on a spatial filter; and
the determining the ground truth beam failure determination associated with the second reference signal of the second serving cell is based on the spatial filter.

22. The UE of claim 19, wherein the UE is further configured to:
receive, from the network unit, the configuration for the ML model via a radio resource control (RRC) message.

23. The UE of claim 19, wherein:
the channel characteristics associated with the first reference signal of the first serving cell comprise channel characteristics associated with the first reference signal in a frequency range 1 (FR1); and
the UE is further configured to receive the second reference signal of the second serving cell in a frequency range 2 (FR2).

24. A user equipment (UE) comprising:
a memory;
a transceiver; and
at least one processor coupled to the memory and the transceiver, wherein the UE is configured to:
receive, from a network unit, a configuration for a machine learning (ML) model, wherein the configuration comprises inputs to the ML model based on a reference signal received power (RSRP) associated with a first reference signal of a first serving cell and an interference level associated with a second reference signal of the first serving cell;
train the ML model based on the input, wherein an output of the ML model includes at least one of an RSRP associated with a second reference signal of a second serving cell, an interference level associated with the second reference signal, or an expected beam failure determination reason associated with the second reference signal;
receive the second reference signal of the second serving cell;
determine a ground truth beam failure determination reason associated with the second reference signal of the second serving cell based on at least one of the RSRP associated with the second reference signal of the second serving cell, an interference level associated with a third reference signal of the second serving cell, or the expected beam failure determination reason; and
determine a loss function between the expected beam failure determination reason associated with the second reference signal of the second serving cell and the ground truth beam failure determination reason associated with the second reference signal of the second serving cell.

25. The UE of claim 24, wherein:
the configuration further comprises at least one of an RSRP threshold or an interference level threshold; and
the UE is further configured to determine the ground truth beam failure determination associated with the second reference signal of the second serving cell based on at least one of the RSRP associated with the second reference signal of the second serving cell satisfying the RSRP threshold or the interference level associated with the third reference signal of the second serving cell satisfying the interference level threshold.

26. The UE of claim 24, wherein the UE is further configured to:
receive, from the network unit, the configuration for the ML model via a radio resource control (RRC) message.

27. The UE of claim 24, wherein:
the RSRP and the interference level associated with the first reference signal of the first serving cell comprise the RSRP and the interference level associated with the first reference signal in a frequency range 1 (FR1); and
the UE is further configured to receive the second reference signal of the second serving cell in a frequency range 2 (FR2).
